(19) United States
(12) Patent Application Publication
(10) Pub. No.: US 2014/0104878 A1
(43) Pub. Date: Apr. 17, 2014

(54) STEREOSCOPIC DISPLAY

(71) Applicant: Industrial Technology Research Institute, Hsinchu (TW)

(72) Inventors: Fu-Hao Chen, Kaohsiung City (TW); Wu-Li Chen, Taipei City (TW); Wei-Ting Yen, Taipei City (TW); Jian-Chiun Liou, Kaohsiung City (TW); Chao-Hsu Tsai, Hsinchu City (TW)

(73) Assignee: Industrial Technology Research Institute, Hsinchu (TW)

(21) Appl. No.: 13/965,212

(22) Filed: Aug. 13, 2013

Related U.S. Application Data
(60) Provisional application No. 61/712,777, filed on Oct. 11, 2012.

(30) Foreign Application Priority Data
Mar. 4, 2013 (TW) 102107542

(51) Int. Cl. G02B 27/22; F21V 8/00

(52) U.S. Cl. CPC G02B 27/22; G02B 6/0011
USPC 362/611

(57) ABSTRACT

A stereoscopic display including a backlight module, a display panel, a light-controlling element and a switching element is provided. The backlight module includes a light source and a light guide plate. The light guide plate has a light incident surface and a light emitting surface. The light-controlling element is disposed between the display panel and the light guide plate. The light-controlling element includes a plurality of light-controlling surface groups. Each of the light-controlling surface groups has a first surface and a second surface opposite to each other. At least one of the first surface and the second surface inclines with respect to the light emitting surface by over 90 degrees. The switching element is configured to switch between a light transmitting mode and a light scattering mode.

### CROSS-REFERENCE TO RELATED APPLICATION

This application claims the priority benefits of U.S. provisional application Ser. No. 61/712,777, filed on Oct. 11, 2012 and Taiwan application serial no. 102107542, filed on Mar. 4, 2013. The entirety of each of the above-mentioned patent applications is hereby incorporated by reference herein and made a part of this specification.

### TECHNICAL FIELD

The technical field relates to a stereoscopic display.

### BACKGROUND

In recent years, as display technology continuously advances, user demands for display qualities (such as image resolution, color saturation, etc) of the display are also increasing. However, in addition to high image resolution and high color saturation, in order to satisfy the user demands of viewing a vivid image, a display device capable of displaying stereoscopic images has also been developed.

In a conventionally developed three-dimensional image display technology, a parallax barrier is mainly used to control images received by the left eye and the right eye of the user. According to visual characteristics of human eyes, when the left eye and the right eye are respectively viewing the same image content while having images of different parallaxes, the human eyes would see a stereoscopic image. In general, a stereoscopic display is to be disposed between a display panel and the human eyes via the barrier, so that the human eyes may see a stereoscopic image.

However, a main usage of the barrier is in its shading effect, which is to absorb light and is unable to be reused. As a result, a light utilization efficiency of the stereoscopic display is severely influenced. Therefore, how to enhance the light utilization efficiency of stereoscopic display while taking into account of a display quality is one of the major issues of the stereoscopic display.

### SUMMARY

One of exemplary embodiments provides a stereoscopic display. The stereoscopic display comprises a backlight module, a display panel, a light-controlling element and a switching element. The backlight module comprises a light source and a light guide plate. The light guide plate has a light incident surface and a light emitting surface. A light beam emitted by the light source enters the light guide plate from the light incident surface and leaves the light guide plate from the light emitting surface. The light-controlling element is disposed between the display panel and the light guide plate. The light-controlling element comprises a plurality of light-controlling surface groups. Each of the light-controlling surface groups has a first surface and a second surface opposite to each other. The first surfaces and the second surfaces of the light-controlling surface groups are arranged along a first direction substantially parallel to the light emitting surface. At least one of the first surface and the second surface inclines with respect to the light emitting surface by over 90 degrees. The switching element is configured to switch between the light transmitting mode and the light scattering mode.

One of the exemplary embodiments provides a stereoscopic display. The stereoscopic display comprises a backlight module, a display panel, a light-controlling element, a light valve and a control unit. The backlight module comprises a light source and a light guide plate. The light source is configured to emit a light beam. The light guide plate has a light incident surface and a light emitting surface. The light beam enters the light guide plate from the light incident surface and leaves the light guide plate from the light emitting surface. The light-controlling element is disposed between the display panel and the light guide plate. The light-controlling element comprises a plurality of light-controlling surface groups. Each of the light-controlling surface groups has a first surface and a second surface opposite to each other. The first surfaces and the second surfaces of the light-controlling surface groups are arranged along a first direction substantially parallel to the light emitting surface. At least one of the first surface and the second surface inclines with respect to the light emitting surface by over 90 degrees. The light coupling device is disposed between the light guide plate and the light-controlling element. The light valve is disposed between the light guide plate and the display panel. The light valve has a plurality of operation regions respectively corresponding to the light-controlling surface groups. When any one of the operation regions opens, a portion of the light beam from the light source is transmitted to the display panel through the operation region. When any one of the operation regions closes, a portion of the light beam from the light source is substantially unable to be transmitted to the display panel through the operation regions. The control unit is electrically connected to the display panel and the light valve. The operation regions are divided into a plurality of operation region groups. The control unit opens different operation region groups at different time points.

One of the exemplary embodiments provides a stereoscopic display. The stereoscopic display comprises a backlight module, a display panel and a light-controlling element. The backlight module comprises a light source and a light guide plate. The light source is configured to emit a light beam. The light guide plate has a light incident surface and a light emitting surface. The light beam enters the light guide plate from the light incident surface and leaves the light guide plate from the light emitting surface. The light-controlling element is disposed between the display panel and the light guide plate. The light-controlling element comprises a plurality of light-controlling surface groups. Each of the light-controlling surface groups has a first surface and a second surface opposite to each other. The first surface inclines a first angle with respect to the light emitting surface of the light guide plate. The second surface inclines a second angle with respect to the light emitting surface of the light guide plate. At least one of the first angle and the second angle falls within a range of 110 degrees to 120 degrees.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic cross-sectional diagram illustrating a stereoscopic display according to an exemplary embodiment.

FIG. 2 is a partial diagram illustrating a light-controlling element and a light valve of FIG. 1.

FIG. 3 is a schematic cross-sectional diagram illustrating a stereoscopic display according to another exemplary embodiment.

FIG. 4 is a partial schematic diagram illustrating a light source and a light guide plate of FIG. 1.

FIG. 5 is distribution diagram of a light beam emitted by the light source of FIG. 4 after passing through a first connecting surface, a first sub-light incident surface, a second sub-light incident surface and a second connecting surface.

FIG. 6 is a schematic diagram illustrating a stereoscopic display operating at a spatial multiplexing mode according to a first exemplary embodiment.

FIG. 7A and FIG. 7B are schematic diagrams illustrating the stereoscopic display operating at a time multiplexing mode according to the first exemplary embodiment.

FIG. 8A and FIG. 8B are schematic diagrams illustrating the stereoscopic display operating at a hybrid multiplexing mode according to the first exemplary embodiment.

FIG. 9A and FIG. 9B are partial schematic diagrams illustrating a light-controlling element, a light valve and a light guide plate of the stereoscopic display according to the first exemplary embodiment.

FIG. 10 is a top view diagram illustrating a first electrodes and a second electrode of the light valve of FIG. 9A and FIG. 9B.

FIG. 11 is schematic diagram illustrating a light valve according to another exemplary embodiment.

FIG. 12 is a schematic cross-sectional diagram illustrating a stereoscopic display according to another exemplary embodiment.

FIG. 13 is a schematic cross-sectional diagram illustrating a stereoscopic display according to yet another exemplary embodiment.

FIG. 14 is a schematic cross-sectional diagram illustrating a stereoscopic display according to still another exemplary embodiment.

FIG. 15 is a schematic cross-sectional diagram illustrating a stereoscopic display according to another exemplary embodiment.

FIG. 16 is a schematic cross-sectional diagram illustrating a stereoscopic display according to another exemplary embodiment.

FIG. 17A and FIG. 17B are schematic cross-sectional diagrams of a stereoscopic display according to still another exemplary embodiment.

FIG. 18A and FIG. 18B are schematic cross-sectional diagrams of a stereoscopic display according to yet another exemplary embodiment.

FIG. 19 is a schematic cross-sectional diagram illustrating a stereoscopic display according to a second exemplary embodiment.

FIG. 20 and FIG. 19 are partial diagrams illustrating a light-controlling element and a light valve.

FIG. 21 is a schematic cross-sectional diagram illustrating a stereoscopic display according to another exemplary embodiment.

### DETAILED DESCRIPTION OF DISCLOSED EMBODIMENTS

### First Exemplary Embodiment

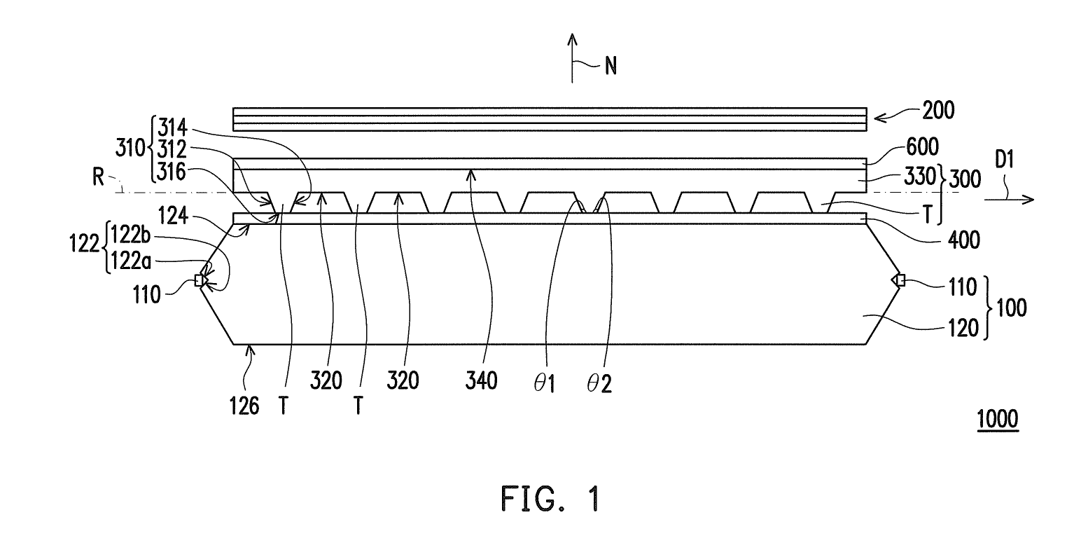

FIG. 1 is a schematic cross-sectional diagram illustrating a stereoscopic display according to an exemplary embodiment. Referring to FIG. 1, a stereoscopic display 1000 of this embodiment comprises a backlight module 100, a display panel 200 and a light-controlling element 300. The display panel 200 is disposed on the backlight module 100. The light-controlling element 300 is disposed between the display panel 200 and a light guide plate 120 of the backlight module 100. In this embodiment, the display panel 200 may be a transmissive display panel, such as a liquid crystal display panel, but the disclosure is not limited thereto.

The backlight module 100 of this embodiment comprises a light source 110 and a light guide plate 120. The light source 110 is configured to emit a light beam. In this embodiment, the light source 110, for example, is a light emitting diode, but the disclosure is not limited thereto. In other embodiments, the light source 110 may be a cold cathode fluorescent tube or any other appropriate light-emitting element. The light guide plate 120 has a light incident surface 122 and a light emitting surface 124. In this embodiment, the light guide plate 120 further has a bottom surface 126 opposite to the light emitting surface 124, and the light incident surface 122 connects the light emitting surface 124 and the bottom surface 126. The light source 110 is disposed beside the light incident surface 122. In other words, the backlight module 100 of this embodiment may be an edge type backlight module.

A light-controlling element 300 of this embodiment may adjust a method for the light beam to leave the light guide plate 120, thereby forming a plurality of line light sources. In the following below, more details accompanied with drawings are provided. The light-controlling element 300 of this embodiment comprises a plurality of light-controlling surface groups 310. Each of the light-controlling surface groups 310 has a first surface 312 and a second surface 314 opposite to each other. The first surfaces 312 and the second surfaces 314 of the light-controlling surface groups 310 are arranged along a first direction D1 substantially parallel to the light emitting surface 124. In this embodiment, each of the light-controlling surface groups 310 further comprises a third surface 316 connecting the first surface 312 and the second surface 314. The third surface 316 may be parallel to the light emitting surface 124.

At least one of the first surface 312 and the second surface 314 of each of the light-controlling surface groups 310 inclines with respect to the light emitting surface 124 by over 90 degree. In detail, if a surface (such as the first surface 312 or the second surface 314) inclines with respect to the light emitting surface 124 by over 90 degree, then this surface faces obliquely towards the light emitting surface 124. If a surface inclines with respect to the light emitting surface 124 by less than 90 degree, then this surface faces obliquely away from the light emitting surface 124, e.g., faces obliquely towards the display panel 200.

In this embodiment, the light-controlling element 300 comprises a plurality of strip-shaped protrusions T. Each of the strip-shaped protrusions T has the first surface 312 and the second surface 314 of one of the light-controlling surface groups 310. Each of the strip-shaped protrusions T further has the third surface 316 of one of the light-controlling surface groups 310. A surface of the strip-shaped protrusions T cut out by a plane (viz., a paper surface of FIG. 1) perpendicular to the light emitting surface 124 may appear to be a trapezoid. A short edge of the trapezoid is located between a long edge of the trapezoid and the light emitting surface 124. In other words, the strip-shaped protrusions T may be an inverted trapezoidal column. In addition, in this embodiment, the first surface 312 inclines a first angle θ1 with respect to the light emitting surface 124. The second surface 134 inclines a second angle θ2 with respect to the light emitting surface 124. At least one of the first angle θ1 and the second angle θ2 may fall within a range of 110 degrees to 120 degrees. The first angle θ1 and the second angle θ2 may be the same or different.

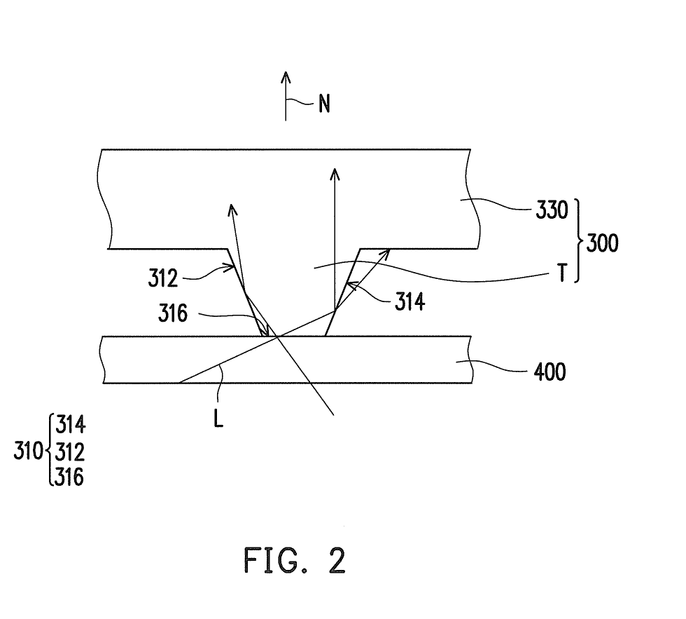

FIG. 2 is a partial diagram illustrating a light-controlling element and a light valve of FIG. 1. Referring to FIG. 1 and FIG. 2, in this embodiment, a design of the light-controlling surface groups 310 is to enable the light beam L to be transmitted out from the light-controlling surface groups 310, thereby fainting the line light sources. As shown in FIG. 2, when the light beam L is transmitted to the strip-shaped protrusions T from a light valve 400, the first surface 312 and the second surface 314 of the light-controlling surface groups 310 may totally reflect and refract the light beam L, so that the light beam L is concentrated toward a normal direction N of the light emitting surface 124. On the other hand, if the light beam L does not go into the strip-shaped protrusions T, then light L may be totally reflected by the light valve 400 to continue to be transmitted in the light guide plate 120, while not passing through the light-controlling element 300. Therefore, a plurality of line light sources may be formed at the light-controlling surface groups 310. The line light sources in coordination with the display panel 200 may transmit images of different viewing angles of the display panel 200 to different view zones, such that the stereoscopic display 1000 may display stereoscopic images.

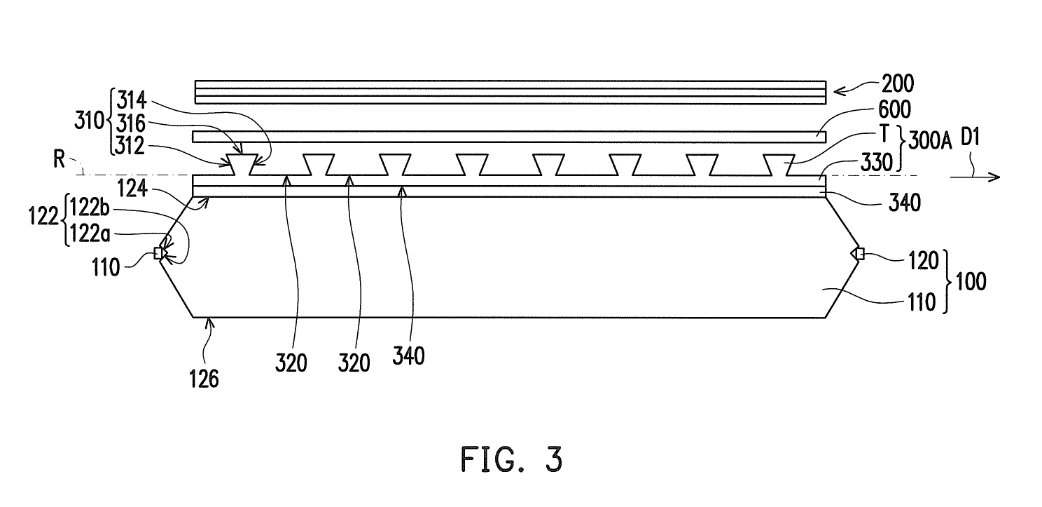

Referring to FIG. 1 again, in this embodiment, the strip-shaped protrusions T may be equidistantly arranged along the first direction D1. The light-controlling element 300 further comprises a plurality of bottom surfaces 320. The bottom surfaces 320 and the strip-shaped protrusions T are alternately arranged. The strip-shaped protrusions T is disposed between a reference plane R where the bottom surfaces 320 are located and the light emitting surface 124 of the light guide plate 120. Specifically, in this embodiment, the light-controlling element 300 further comprises a connection substrate 330. The connection substrate 330 has the bottom surfaces 320. The connection substrate 330 is connected to the strip-shaped protrusions T. The strip-shaped protrusions T are disposed between the connection substrate 330 and the light emitting surface 124. However, a configuration of the strip-shaped protrusions T is not limited to the one mentioned above. In other embodiments, the strip-shaped protrusions T may also be disposed with other configurations. FIG. 3 is a schematic cross-sectional diagram illustrating a stereoscopic display according to another exemplary embodiment. Referring to FIG. 3, in this embodiment, a light-controlling element 300A comprises a plurality of bottom surfaces 320. The bottom surfaces 320 and the strip-shaped protrusions T are alternately arranged. A reference plane R where the bottom surfaces 320 are located is disposed between the strip-shaped protrusions T and the light emitting surface 124 of the light guide plate 120. Specifically, the light-controlling element 300A further comprises the connection substrate 330. The connection substrate 330 has the bottom surfaces 320. The connection substrate 330 is disposed between the strip-shaped protrusions T and the light emitting surface 124.

Referring to FIG. 1 again, the light-controlling element 300 of this embodiment further comprises a top surface 340 opposite to the bottom surfaces 320. At least one of the top surface 340 and the bottom surfaces 320 may be designed as a light scattering surface, such as a rough surface. The light scattering surface may enable the light beam to be scattered to a plurality of directions when the light beam arrives the connection substrate 330, thereby increasing the viewing angles of the stereoscopic display 1000 of this embodiment. Furthermore, a refractive index of the connection substrate 330 may be different from a refractive index of the strip-shaped protrusions T. When a difference between the refractive index of the connection substrate 330 and the refractive index of the strip-shaped protrusions T becomes larger, an effect of the connection substrate 330 in deflecting the light beam becomes more obvious, and thus the viewing angle of the stereoscopic display 1000 of this embodiment is enlarged.

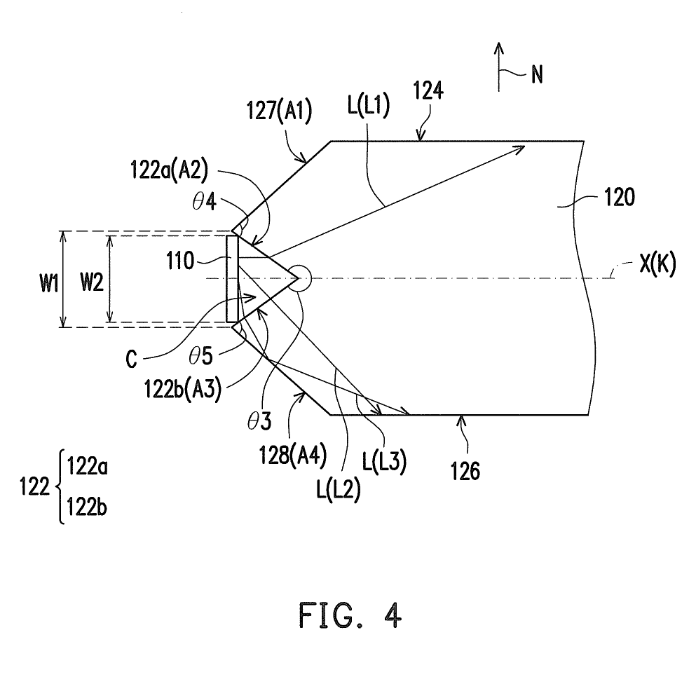

In this embodiment, in order to increase an optical coupling efficiency of the light guide plate 120, the light incident surface 122 of the light guide plate 120 may be specially designed. In the following below, more details accompanied with FIG. 1 and FIG. 4 are provided. FIG. 4 is a partial schematic diagram illustrating a light source and a light guide plate of FIG. 1. Referring to FIG. 1 and FIG. 4, the light guide plate 120 has the bottom surface 126 opposite to the light emitting surface 124. The light emitting surface 124 is located between the display panel 200 and the bottom surface 126. As shown in FIG. 4, the light source 110 has an optical axis X. The optical axis X is located on a reference plane K parallel to the light emitting surface 124. The light incident surface 122 comprises a first sub-light incident surface 122a and a second sub-light incident surface 122b respectively located at two different sides of the reference plane K. The first sub-light incident surface 122a connects the light emitting surface 124 and the second sub-light incident surface 122b. The second sub-light incident surface 122b connects the first sub-light incident surface 122a and the bottom surface 126. The first sub-light incident surface 122a and the second sub-light incident surface 122b incline with respect to the reference plane K and face toward the optical axis X. In other words, the first sub-light incident surface 122a and the second sub-light incident surface 122b incline with respect to the reference plane K by over 90 degree. In the present embodiment, the first sub-light incident surface 122a in respect to the reference plane K may appear to be in mirror symmetry with the second sub-light incident surface 122b. An angle θ3 between the first sub-light incident surface 122a and the second sub-light incident surface 122b within a material of the light guide plate 120 may fall within a range of 270 degrees to 300 degrees.

As shown in FIG. 4, the light guide plate 120 of this embodiment further has a first connecting surface 127 connecting the first sub-light incident surface 122a and the light emitting surface 124 and a second connecting surface 128 connecting the second sub-light incident surface 122b and the bottom surface 126. The first connecting surface 127 and the second connecting surface 128 respectively are located at the two different sides of the reference plane K. The first connecting surface 127 and the second connecting surface 128 incline with respect to the reference plane K and face away from the optical axis X of the light source 110. In this embodiment, the first connecting surface 127 with respect to the reference plane K may appear to be in mirror symmetry with the second connecting surface 128. From another perspective, cut lines A1, A2, A3 and A4 of the first connecting surface 127, the first sub-light incident surface 122a, the second sub-light incident surface 122b and the second connecting surface 128 cut out by a plane (viz., a paper surface of FIG. 4) perpendicular to the light emitting surface 124 may connect into a W-shape. In this embodiment, each of an angle θ4 between the first connecting surface 127 and the first sub-light incident surface 122a within the material of the light guide plate 120 and an angle θ5 between the second connecting surface 128 and the second sub-light incident surface 122b within the material of the light guide plate 120 may fall in a range of 40 degrees to 80 degrees.

Moreover, in this embodiment, a maximum width W1 of a recession C constituted by the first sub-light incident surface 122a and the second sub-light incident surface 122b at a normal direction N of the light emitting surface 124 may be greater than a maximum width W2 of the light source 110 at the normal direction N of the light emitting surface 124. As such, the light source 110 of this embodiment may be disposed in the recession C constituted by the first sub-light incident surface 122a and the second sub-light incident surface 122b. A light beam L1, with a smaller deviation angle, emitted by the light source 110, may be refracted by the first sub-light incident surface 122a to the light emitting surface 124. The light beam L1 refracted to the light emitting surface 124 may be totally reflected by the light emitting surface 124 and thereby transmitted in the light guide plate 120. A light beam L2, with a larger deviation angle, emitted by the light source 110, may be refracted by the second sub-light incident surface 122b to the bottom surface 126 and thereby transmitted in the light guide plate 120. A light beam L3, with an even larger deviation angle, emitted by the light source 110, may be refracted by the second sub-light incident surface 122b to the second connecting surface 128. The light beam L3 refracted to the second connecting surface 128 may be totally reflected by the second connecting surface 128 to the bottom surface 126, and thereby transmitted in the light guide plate 120.

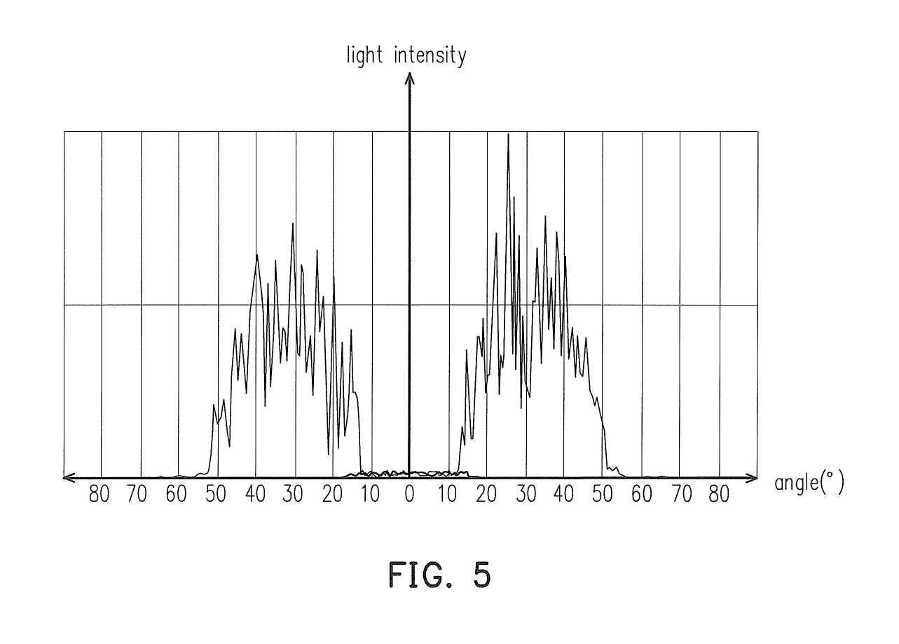

FIG. 5 is distribution diagram of a light beam emitted by the light source of FIG. 4 after passing through a first connecting surface, a first sub-light incident surface, a second sub-light incident surface and a second connecting surface. Particularly, the angle in FIG. 5 is referred to an angle between the light beam L and the optical axis X of the light source 110. It is apparent from FIG. 5, after the light beam L emitted by the light source passes through the first connecting surface 127, the first sub-light incident surface 122a, the second sub-light incident surface 122b and the second connecting surface 128, the angle between the light beam L and the optical axis X is concentrated between 15 to 50 degrees and −50 to −15 degrees, and thus probability of the light beam L being totally reflected by the bottom surface 126 and by the light emitting surface 124 is increased. In other words, through the first connecting surface 127, the first sub-light incident surface 122a, the second sub-light incident surface 122b and the second connecting surface 128, the optical coupling efficiency of the light guide plate 120 may be effectively enhanced.

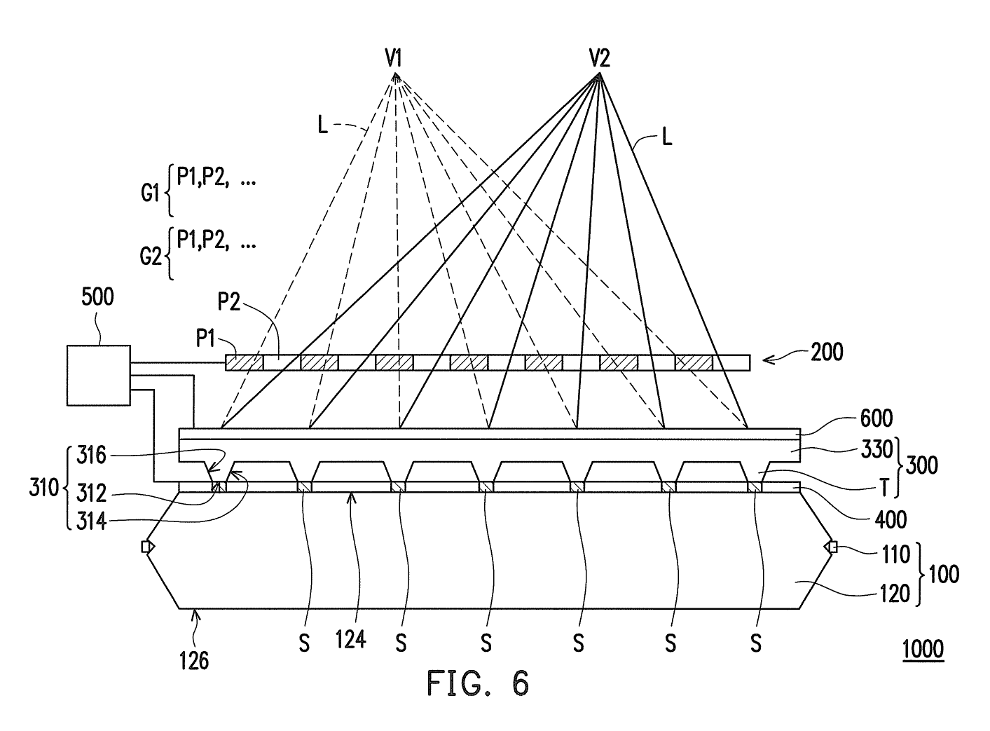

FIG. 6 is a schematic diagram illustrating a stereoscopic display operating in a spatial multiplexing mode according to a first exemplary embodiment. Referring to FIG. 6, the stereoscopic display 1000 of this embodiment further comprises a light valve 400 and a control unit 500 electrically connected to a display panel 200 and the light valve 400. The light valve 400 is disposed between the light guide plate 120 and the display panel 200. In this embodiment, the light valve 400 may be disposed between the light guide plate 120 and the light-controlling element 300. The light valve 400 has a plurality of operation regions S respectively corresponding to a plurality of light-controlling surface groups 310. When any one of the operation regions S opens, a portion of the light beam L from the light source 110 is transmitted to the display panel 200 through the operation region S. When any one of the operation regions S closes, the light beam L from the light source 110 is substantially unable to be transmitted to the display panel 200 through the operation region S. The control unit 500 may be electrically connected with the display panel 200 and the light valve 400. The control unit 500 may control whether or not the light beam emitted from the light emitting surface 124 is to pass through the operation regions S.

The display panel 200 of this embodiment has a plurality of pixel groups G1, G2. Each of the pixel groups G1(or G2) has a plurality of pixel rows P1(or P2). The operation regions S may be slanted or substantially parallel with respect to the pixel rows P1, P2. In this embodiment, the control unit 500 may enable the light beam L to pass through the operation regions S at the same time. The light beam L transmitted through and out of the operation regions S is respectively converged at a plurality of view zones V1, V2 after passing through the pixel groups G1, G2. Furthermore, the pixel groups G1, G2 are M pixel groups, wherein M is a positive integer greater than or equal to 2. Disposed between two pixel rows P1(or P2) adjacent to each other in each of the pixel groups G1 (or G2) are M−1 pixel rows P2(or P1) respectively belonging to other M−1 pixel groups. The control unit 500 enables the M pixel groups G1, G2 to respectively display images of M different viewing angles. The light beam L transmitted through and out of the operation regions S is respectively converged at M view zones V1, V2 after passing through the pixel groups G1, G2.

For example, in this embodiment, the pixel groups G1, G2 are 2 pixel groups. Disposed between the two pixel rows P1(or P2) adjacent to each other in each of the pixel groups G1(or G2) is one of the pixel rows P2(or P1) belonging to one of the other pixel groups. The control unit 500 enables the 2 pixel groups G1, G2 to respectively display images of 2 different viewing angles. The light beam L transmitted through and out of the operation regions S is respectively converged at 2 view zones V1, V2 after passing through the plurality of pixel groups G1, G2. As such, when the left eye and the right eye of a user are respectively at the view zone V1 and the view zone V2, the left eye and the right eye can respectively observe images of different viewing angles, and a parallax between the images of different viewing angles can enable the user's brain to sense a stereoscopic image. Such a stereoscopic display mode is referred to as a spatial multiplexing mode.

However, the disclosure is not limited to the above. Through the light valve 400, the stereoscopic display 1000 of this embodiment may control whether or not the line light sources formed by the light-controlling surface groups 310 are turned on, and thereby enable the stereoscopic display 1000 to be operated under a time multiplexing mode and a hybrid multiplexing mode. In the following below, details regarding conditions of operating the stereoscopic display 1000 under the time multiplexing mode and the hybrid multiplexing mode are firstly described, together with drawings. Afterward, examples for describing how the light valve 400 controls whether or not the line light sources formed the by the light-controlling surface groups 310 are turned on.

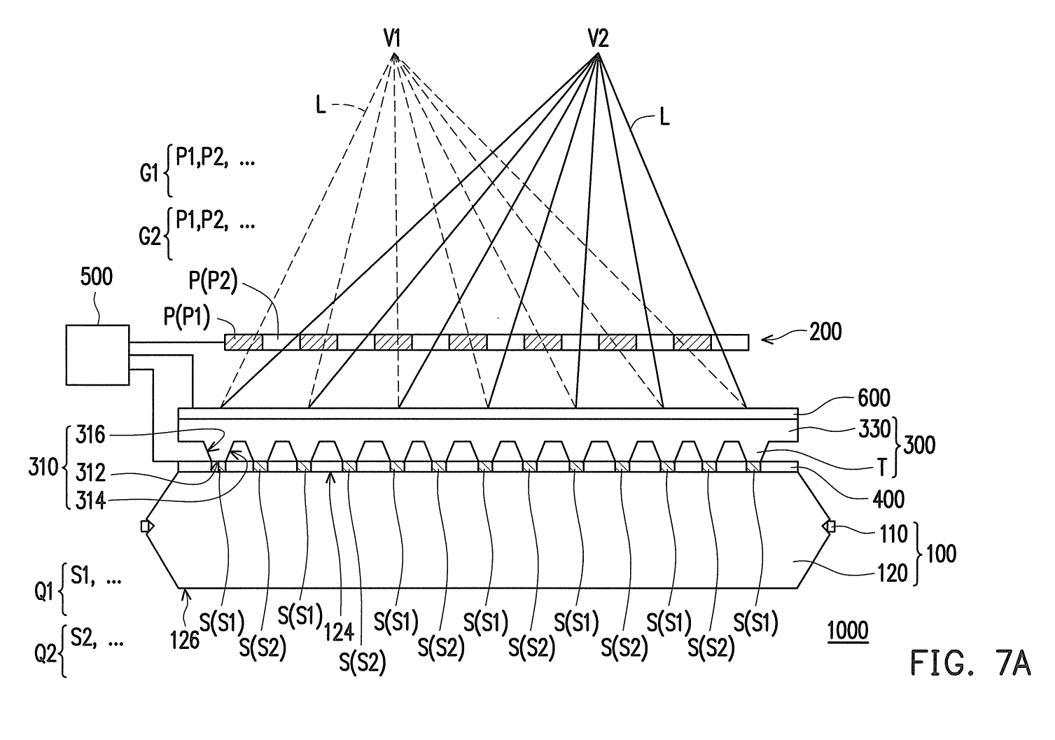

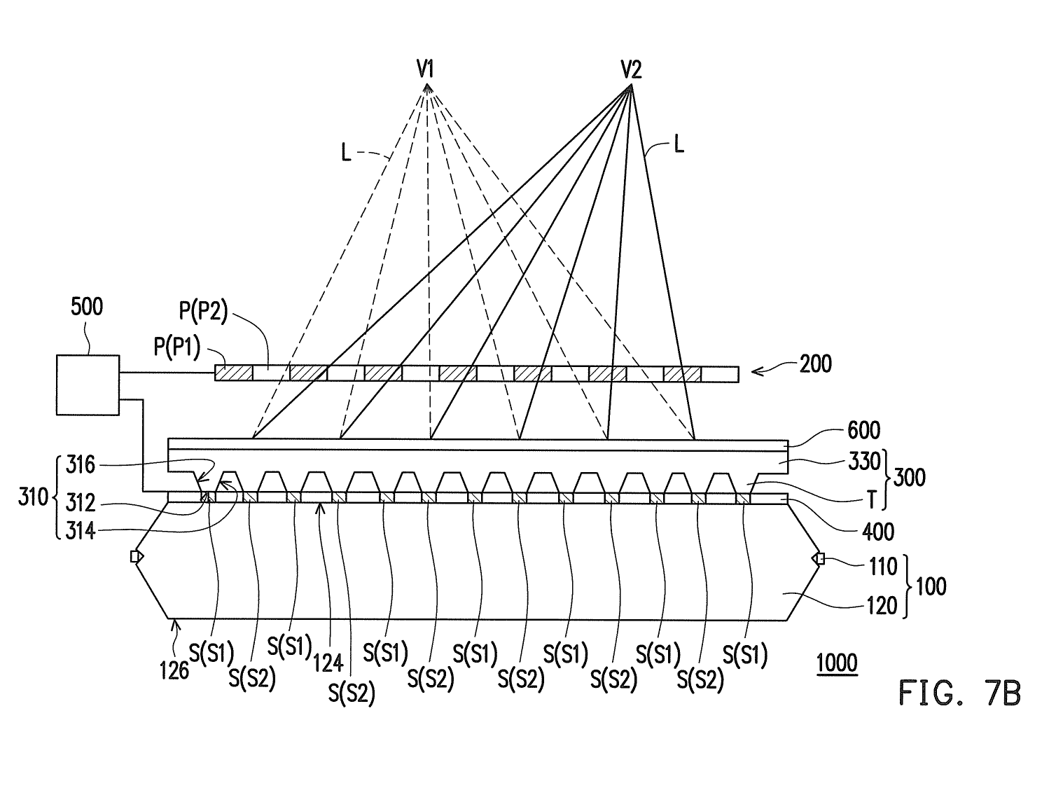

FIG. 7A and FIG. 7B are schematic diagrams illustrating the stereoscopic display operating at a time multiplexing mode according to the first exemplary embodiment. Referring to FIG. 7A and FIG. 7B, the control unit 500 is electrically connected to the display panel 200 and the light valve 400. The operation regions S are divided into a plurality of operation region groups S1, S2. The control unit 500 opens different operation region groups S1, S2 at different time points. The control unit 500 opens N operation region groups S1, S2 by turns and causes a timing for the light beam L to pass through the operation region groups S1, S2 to match an image displayed by the display panel 200, thereby displaying a high-resolution stereoscopic image. The control unit 500 divides the operation regions S into N operation region groups Q1, Q2, wherein N is a positive integer greater than or equal to 2. The operation region group Q1 comprises a plurality of operation regions S1. One operation region group Q2 comprises a plurality of operation regions S2. The light beam L transmitted through and out of each operation region group Q1(or Q2) is respectively converged at the view zones V1, V2 after passing through the pixel groups G1, G2. Disposed between two operation regions S1 (or S2) adjacent to each other in each operation region group Q1 (or Q2) are N−1 operation regions S2 (or S1) of other N−1 operation region groups. The control unit 500 enables the light beam L to pass through the N operation region groups Q1, Q2 by turns.

In this embodiment, within the same time, the control unit 500 enables M pixel groups G1, G2 to respectively display 1/N images of M different viewing angles. For example, when the stereoscopic display 1000 is in a condition depicted by FIG. 7A, the pixel rows P1 display half of an image of the view zone V1, and the pixel rows P2 display half of an image of the view zone V2. When the stereoscopic display 1000 is in a condition depicted by FIG. 7B, the pixel rows P1 display the other half of the image of the view zone V2, and the pixel rows P2 display the other half of the image of the view zone V1. When the stereoscopic display 1000 is alternating between the display conditions depicted by FIG. 7A and FIG. 7B, the stereoscopic display 1000 can provide full resolution images; namely, the image displayed by the pixel rows P1 depicted in FIG. 7A in addition with the image displayed by the pixel rows P2 depicted in FIG. 7B compose the full resolution image that is transmitted to the view zone V1. The image displayed by the pixel rows P2 depicted in FIG. 7A in addition with the image displayed by the pixel rows P1 depicted in FIG. 7B compose the full resolution image that is transmitted to the view zone V2. In other words, the stereoscopic display 1000 may adopt a time multiplexing display mode to achieve the display of full resolution images.

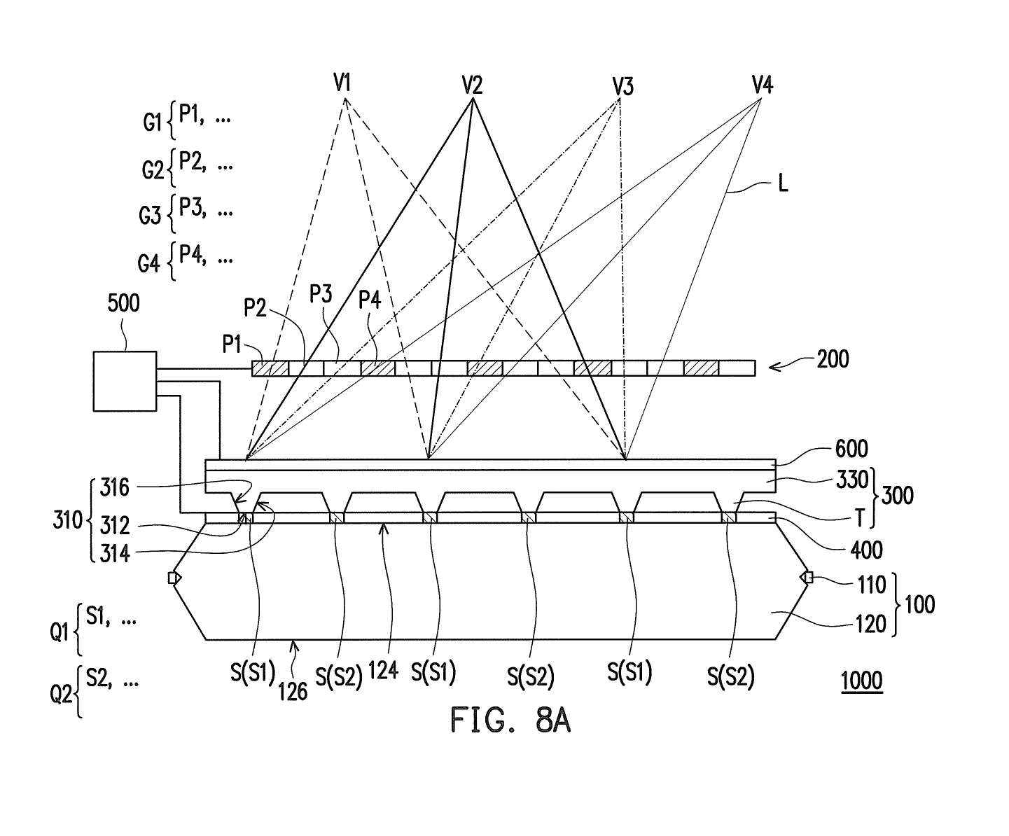

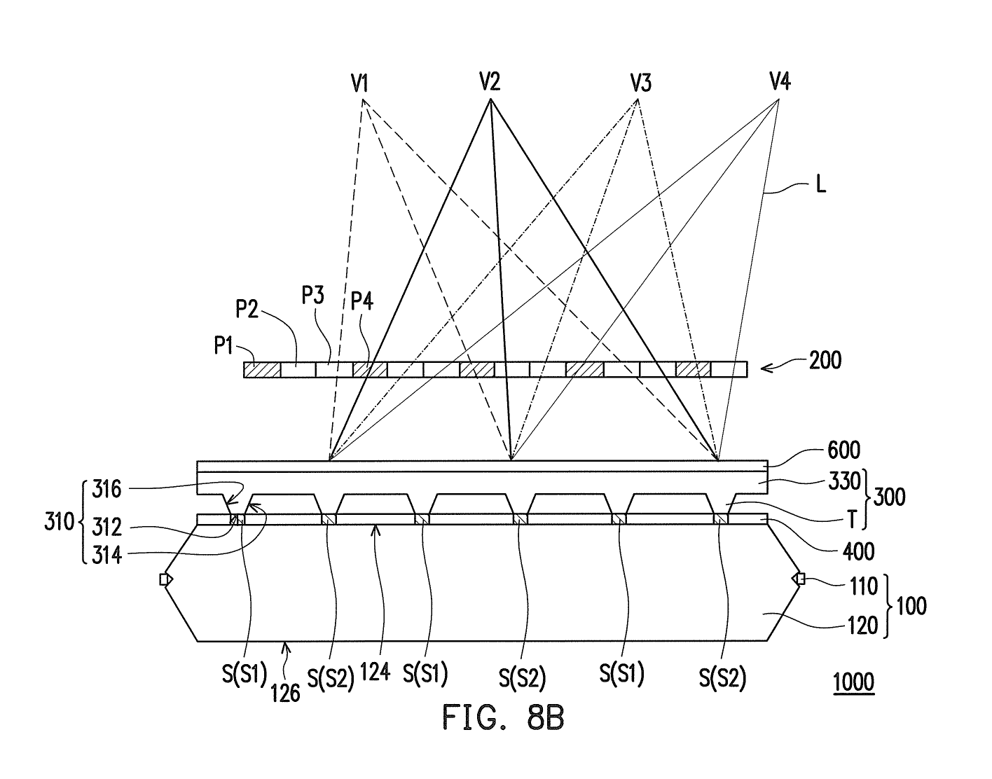

FIG. 8A and FIG. 8B are schematic diagrams illustrating the stereoscopic display operating at a hybrid multiplexing mode according to the first exemplary embodiment. Referring to FIG. 8A and FIG. 8B, the control unit 500 divides the operation regions S into 2 operation region groups Q1, Q2. The display panel 200 has a plurality of pixel groups G1, G2, G3, and G4. The light beam L transmitted through and out of each operation region group Q1(or Q2) is respectively converged at a plurality of view zones V1, V2, V3, and V4 after passing through the pixel groups G1, G2, G3, and G4. Disposed between the two operation regions S1 (or S2) adjacent to each other in each operation region group Q1 (or Q2) is one operation region S2 (or S1) of another operation region group. The control unit 500 enables the light beam L to pass through the 2 operation region groups Q1, Q2 by turns.

In this embodiment, within the same time, the control unit 500 enables 4 pixel groups G1, G2, G3, G4 to respectively display ½ images of 4 different viewing angle. For example, when the stereoscopic display 1000 is in a condition depicted by FIG. 8A, pixel rows P1 display half of an image of the view zone V1, pixel rows P2 display half of an image of the view zone V2, pixel rows P3 display half of an image of the view zone V3, and pixel rows P4 display half of an image of the view zone V4. When the stereoscopic display 1000 is in a condition depicted by FIG. 8B, the pixel rows P1 display another half of the image of the view zone V3, the pixel rows P2 display another half of the image of the view zone V4, the pixel rows P3 display another half of the image of the view zone V1, and the pixel rows P4 display another half of the image of the view zone V2. When the stereoscopic display 1000 is alternating between the conditions depicted by FIG. 8A and FIG. 8B, the stereoscopic display 1000 can provide high resolution images within the four view zones, namely, the image displayed by the pixel rows P1 in FIG. 8A in addition with the image displayed by the pixel rows P3 in FIG. 8B compose the high resolution image that is transmitted to the view zone V1. The image displayed by the pixel rows P2 in FIG. 8A in addition with the image displayed by the pixel rows P4 in FIG. 8B compose the high resolution image that is transmitted to the view zone V2. The image displayed by the pixel rows P3 in FIG. 8A in addition with the image displayed by the pixel rows P1 in FIG. 8B compose the high resolution image that is transmitted to the view zone V3. The image displayed by the pixel rows P4 in FIG. 8A in addition with the image displayed by the pixel rows P2 in FIG. 8B compose the high resolution image that is transmitted to the view zone V4. Through the hybrid multiplexing mode, the stereoscopic display 1000 may provide high-resolution stereoscopic image to a plurality of people.

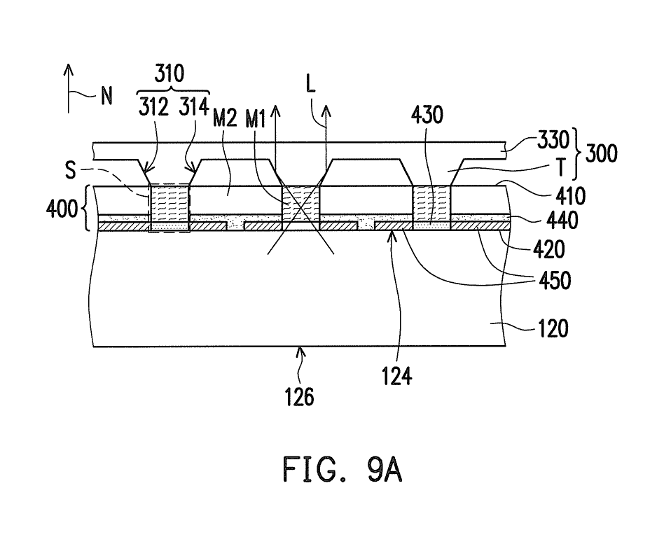

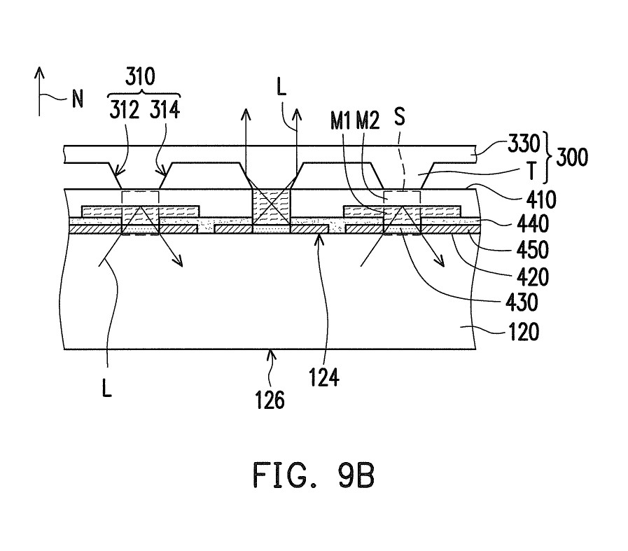

Details regarding how the light valve 400 of this embodiment controls whether or not the line light sources formed by the light-controlling surface groups 310 are turned on is described, together with FIG. 9A and FIG. 9B, in the following below.

FIG. 9A and FIG. 9B are partial schematic diagrams illustrating a light-controlling element, a light valve and a light guide plate of the stereoscopic display according to the first exemplary embodiment. Referring to FIG. 9A, in the present embedment, the light valve 400 may be a light coupling device. The light coupling device has a plurality of light couple switching regions. The light couple switching regions of the light coupling device is the operation regions S of the light valve 400. Each of the operation regions S extends from the light guide plate 120 to the light-controlling element 300. In detail, in this embodiment, two opposite side of the light valve 400 may respectively be in contact with the light-controlling element 300 and the light emitting surface 124 of the light guide plate 120. In detail, in this embodiment, each of the operation regions S may extend from the light emitting surface 124 to the strip-shaped protrusions T.

In this embodiment, the control unit 500 (illustrated in FIG. 1) controls a refractive index distribution of each of the operation regions S to control whether or not the light beam L emitted from the light emitting surface 124 is to pass through the operation regions S. In the present embodiment, the control unit 500 is configured to enable each of the operation regions S to completely fill up the first substance M1, so that the light beam L emitted from the light emitting surface 124 may pass through the operation regions S. A refractive index of the first substance M1 may be substantially equal to a refractive index of the light guide plate 120. As shown in FIG. 9A, when the operation regions S are completely filled with the first substance M1, the light beam L within the light guide plate 120 may be transmitted in the first substance M1 and thereby pass through the operation regions S to arrive at the light-controlling surface groups 310. Now, the line light sources formed by the light-controlling surface groups 310 can be turned on.

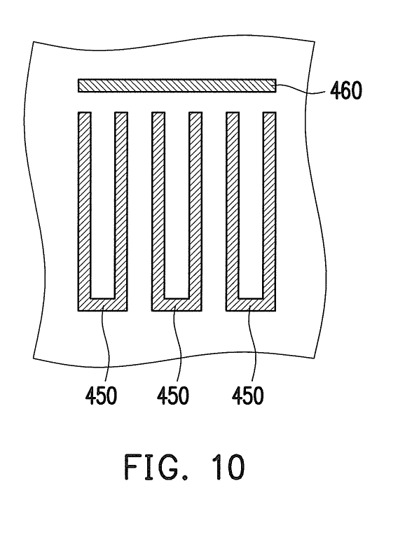

As shown in FIGS. 9A and 9B, the light valve 400 of this embodiment comprises a first substrate 410, a second substrate 420 disposed between the first substrate 410 and the light guide plate 120, a first substance M1 and a second substance M2 filled between the first substrate 410 and the second substrate 420, a plurality of first films 430, a plurality of second films 440, a plurality of first electrodes 450 and at least one second electrode 460 (illustrated in FIG. 10). The first films 430 are located between the second substrate 420 and the whole of the first substance M1 and the second substance M2. An orthogonal projection of each of the first films 430 on the light emitting surface 124 coincides with an orthogonal projection of the operation region S on the light emitting surface 124. The second films 440 are located between the second substrate 420 and the whole of the first substance M1 and the second substance M2. Each of the second films 440 is located between two operation regions S adjacent to each other. Each of the first electrodes 450 is disposed between the second substrate 420 and two second films 440 located at two sides of the operation regions S.

FIG. 10 is a top view diagram illustrating a first electrodes and a second electrode of the light valve of FIG. 9A and FIG. 9B. Referring to FIG. 9A, FIG. 9B and FIG. 10, at least one second electrode 460 is disposed between the first substrate 410 and the second substrate 420.

Referring to FIG. 9A again, the control unit 500 enables a voltage difference between the first electrodes 450 located between the two sides of each of the operation regions S and the second electrode 460 to substantially be zero to enable the operation regions S to completely fill up the first substance M1. In detail, since an adhesive force between the first substance M and the first films 430 is greater than an adhesive force between the first substance M1 and second films 440, when the voltage difference between the first electrodes 450 and the second electrode 460 is substantially zero, the first substance M is naturally concentrated on the first films 430 and does not remain on the second films 440. As such, the first substance M1 may fill up the entire operation regions S so that the light beam L pass through the operation regions S via the first substance M1, thereby forming a plurality of line light sources. In this embodiment, the first films 430 may be hydrophilic membranes, the second films 440 may be hydrophobic membranes, the first substance M1 may be ionized water, and the second substance M2 may be air, but the disclosure is not limited thereto.

Referring to FIG. 9B, the control unit 500 (illustrated in FIG. 1) may be configured to enable each of the operation regions S to fill up the first substance M1 at an end close to the light guide plate 120 and fill up the second substance M2 in contact with the first substance M1 at the other end away from the light guide plate 120. The refractive index of the first substance M1 is greater than a refractive index of the second substance M2. More specifically, the control unit 500 applies a voltage difference between the first electrodes 450 located at the two sides of each of the operation regions S and the second electrode 460 to enable the operation regions S to fill up the first substance M1 at the end close to the light guide plate 120 and to fill up the second substance M2 at the other end away from the light guide plate 120. For example, the first electrodes 450 may have positive voltages, and the first substance M1 may be ionized water with negative charges, the first substance M1 with the negative charges is attracted to the first electrodes 450 with positive voltages thereby staying at the end close to the light guide plate 120, and the second substance M2 is repelled by the first substance M1 thereby staying at the other end away from the light guide plate 120. Now, the light beam L emitted from the light emitting surface 124 is totally reflected at a junction of the first substance M1 and the second substance M2, and thus unable to pass through the operation regions S. As such, the light-controlling surface groups 310 corresponding to the operation regions S are unable to reflect and refract the light beam L for forming the line light sources.

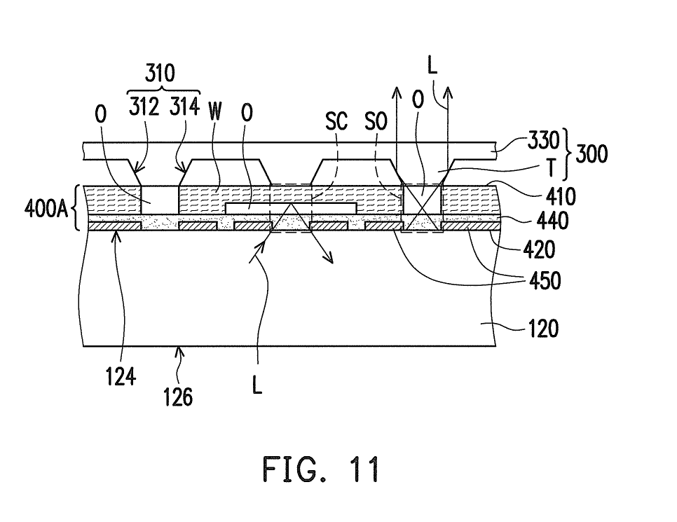

A specific structure of the light valve is not limited to the one shown in FIG. 9A and FIG. 9B. The light valve may have a variety of implementations. FIG. 11 is schematic diagram illustrating a light valve according to another exemplary embodiment. A light valve 400A may also control whether or not the line light sources formed by the light-controlling surface groups 310 is to be turned on. The following below, together with FIG. 11, a specific structure and a working principle of the light valve 400A are to be described. Referring to FIG. 11, the light valve 400A comprises the first substrate 410, the second substrate 420 disposed between the first substrate 410 and the light guide plate 120, the second film 440 disposed between the second substrate 420 and the whole of a first substance O and a second substance W, the first electrodes 450 and at least one second electrode 460 disposed between the first substrate 410 and the second substrate 420 (can refer to FIG. 10). The first substance O and the second substance W are filled between the first substrate 410 and the second substrate 420. The first electrodes 450 are disposed between the second film 440 and the second substrate 420. One first electrodes 450 is disposed at two opposite sides of each of operation regions SC, SO. In the present embodiment, the second film 440 may be a hydrophobic membrane, and the first substance O and the second substance W may be two immiscible liquids. For example, the first substance O may be oil, and the second substance W may be ionized water.

In FIG. 11, the control unit 500 (illustrated in FIG. 1) enables a voltage difference between the first electrodes 450 located at the two sides of the operation region SC and the second electrode 460 to substantially be zero to enable the operation region SC to fill up the first substance O at an end close to the light guide plate 120 and to fill up the second substance W at the other end away from the light guide plate 120.

In detail, since an adhesive force between the second substance W and the second film 440 is smaller than an adhesive force between the first substance O and the second film 440, when the voltage difference between the first electrodes 450 and the second electrode 460 is substantially zero (viz. when no electrostatic interaction is generated by an external voltage), the first substance O naturally stays at a location near the second film 440, and the second substance W is repelled by the first substance O to a location away from the second film 440. Now, the light beam L when passing through the operation region SC is totally reflected by the junction of the first substance O and the second substance W, thereby unable to pass through the operation region SC. As such, the light-controlling surface groups 310 corresponding to the operation region SC are unable to reflect or refract the light beam L for forming the line light sources.

On the other hand, in FIG. 10, the control unit 500 (illustrated in FIG. 1) applies a voltage difference between the first electrodes 450 located at the two side of the operation region SO and the second electrode 460 to enable the operation region SO to completely fill up the first substance O. For example, the first electrodes 450 may be applied with positive voltages, the second substance W may be ionized water with negative charges, the second substance W with negative charges is attracted by the first electrodes with positive voltages thereby stays above the first electrodes 450, and the first substance O is repelled by the second substance W thereby fills up the entire operation region SO. As such, the light beam L may pass through the operation region SO via the first substance O, so as to form the line light sources via the light-controlling surface groups 310 corresponding to the operation region SO.

Referring to FIG. 1 again, the stereoscopic display 1000 of this embodiment may further comprise a switching element 600. The switching element 600 is configured to switch between a light transmitting mode and a light scattering mode. When the switching element 600 is switched to the light transmitting mode, the stereoscopic display 1000 may display a three-dimensional image. When the switching element 600 is switched to the light scattering mode, the stereoscopic display 1000 may display a two-dimensional image. In this embodiment, the light-controlling element 300 may be located between the switching element 600 and the light guide plate 120. However, the disclosure is not limited thereto, such that the switching element 600 may also be disposed at other appropriate locations.

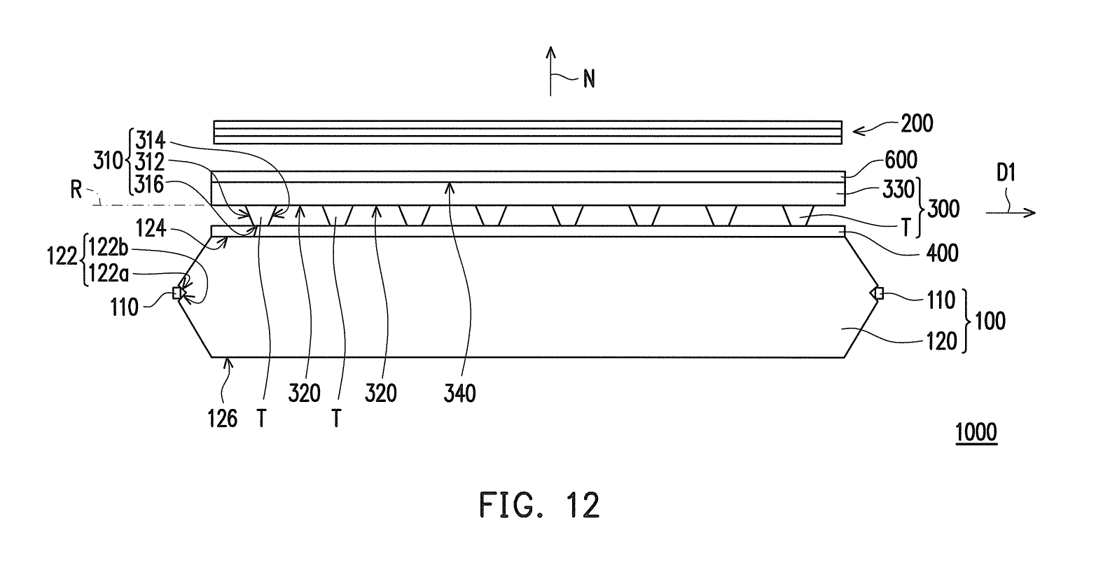

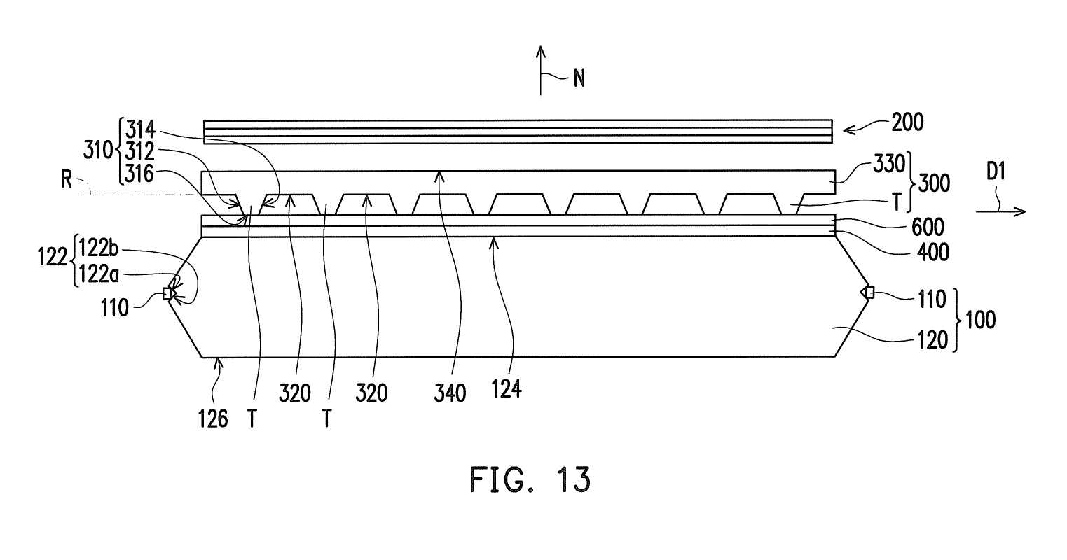

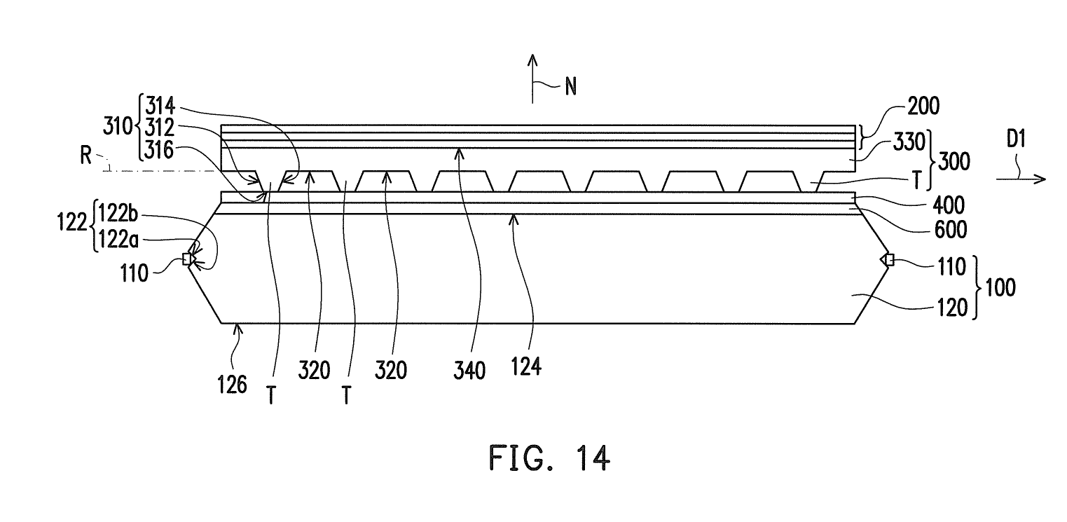

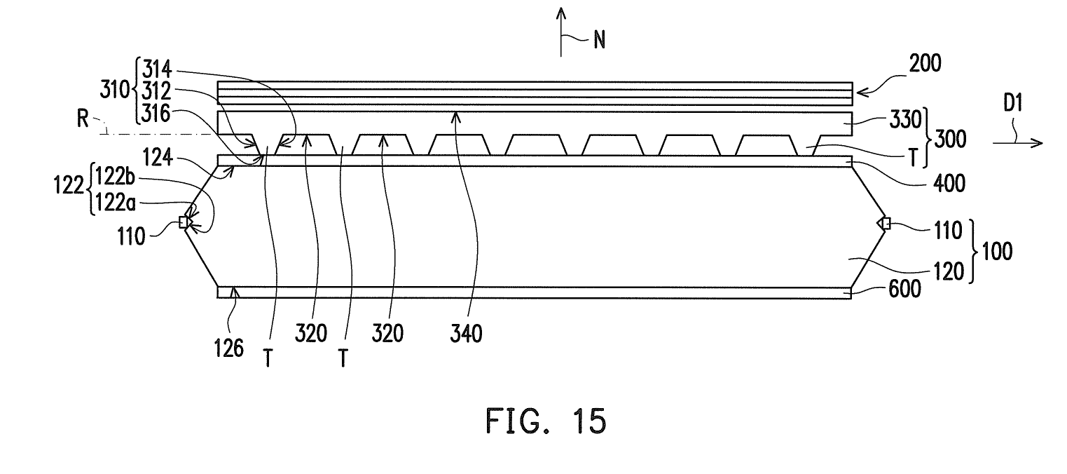

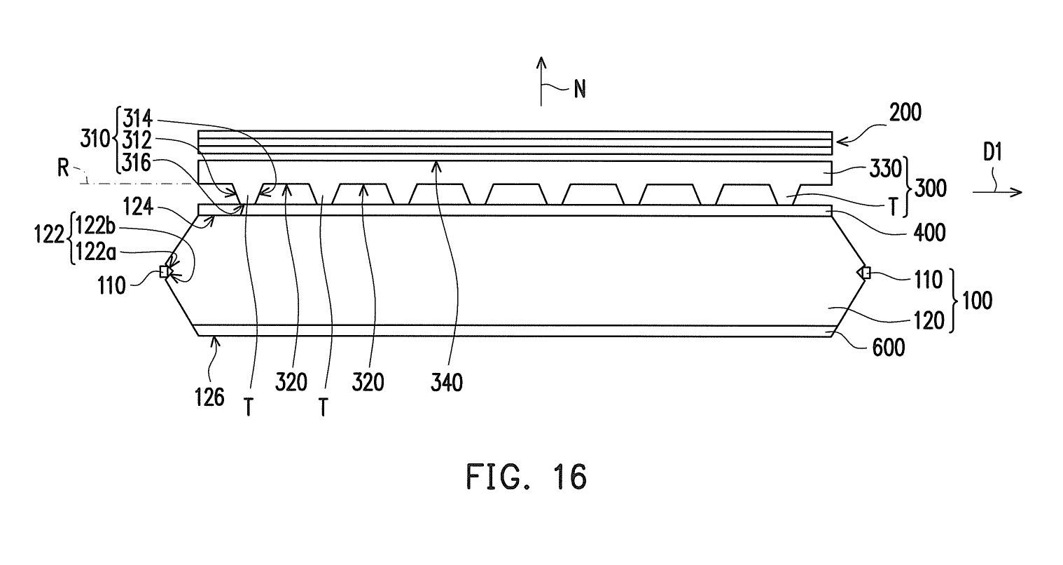

FIG. 12 is a schematic cross-sectional diagram illustrating a stereoscopic display according to another exemplary embodiment. Referring to FIG. 12, in this embodiment, the switching element 600 may be integrated in the connection substrate 330 of FIG. 1. FIG. 13 is a schematic cross-sectional diagram illustrating a stereoscopic display according to yet another exemplary embodiment. Referring to FIG. 13, in this embodiment, the switching element 600 is also located between the light-controlling element 300 and the light guide plate 120. FIG. 14 is a schematic cross-sectional diagram illustrating a stereoscopic display according to still another exemplary embodiment. Referring to FIG. 14, in this embodiment, the switching element 600 may be embedded in the light guide plate 120 and be in contact with the light emitting surface 124 of the light guide plate 120. FIG. 15 is a schematic cross-sectional diagram illustrating a stereoscopic display according to an exemplary embodiment. Referring to FIG. 15, in this embodiment, the light guide plate 120 may be located between the light-controlling element 300 and the switching element 600. FIG. 16 is a schematic cross-sectional diagram illustrating a stereoscopic display according to another exemplary embodiment. Referring to FIG. 16, in this embodiment, the switching element 600 may be embedded in the light guide plate 120 and be in contact with the bottom surface 126 of the light guide plate 120.

Referring to FIG. 1 again, the switching element 600 of the present embodiment may be an electric variable light scattering structure. For example, the switching element 600 may be a polymer dispersed liquid crystal (PDLC) panel. When the switching element 600 is activated, the switching element 600 may be in the light transmitting mode, so now, the stereoscopic display 1000 may display the three-dimensional image. When the switching element 600 is not activated, the switching element 600 may be in the light scattering mode, so now, the stereoscopic display 1000 may display the two-dimensional image.

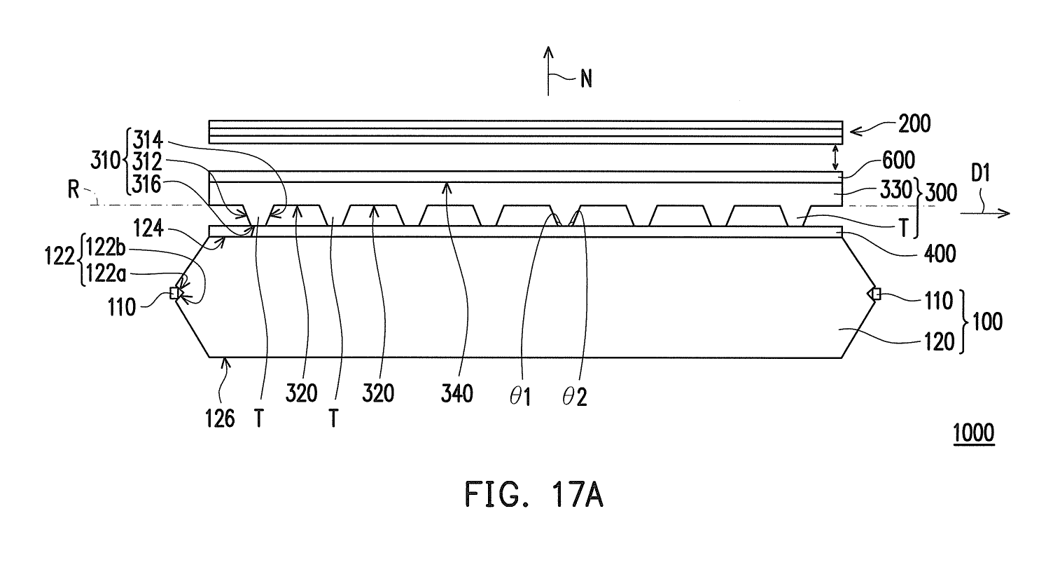

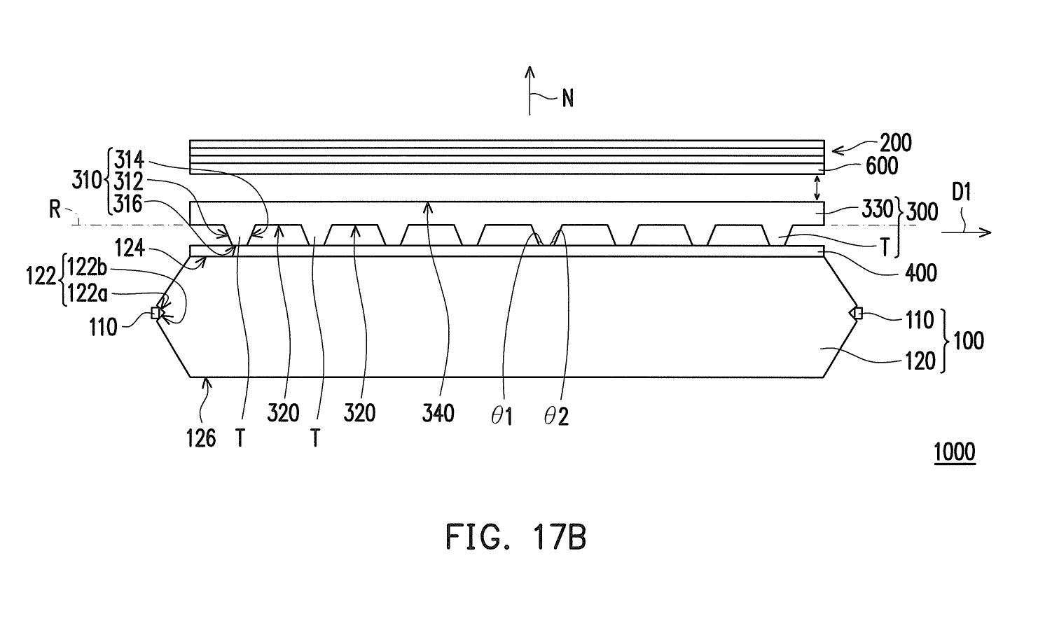

However, the switching element 600 of the disclosure is not limited to the aforementioned forms. FIG. 17A and FIG. 17B are schematic cross-sectional diagrams of a stereoscopic display according to still another exemplary embodiment. Referring to FIG. 17A and FIG. 17B, in this embodiment, the switching element 600 may be a light scattering structure (e.g., a diffusion sheet). The light scattering structure is located between the display panel 200 and the light-controlling element 300. As shown in FIG. 17A, when the switching element 600 is switched from the light scattering mode to the light transmitting mode, the switching element 600 moves toward the light-controlling element 300 and close to the light-controlling element 300. As such, the light beam emitted from the light-controlling element 300 is not overly spread, so that the stereoscopic display 1000 may still display the three-dimensional image. As shown in FIG. 17B, when the switching element 600 is switched from the light transmitting mode to the light scattering mode, the switching element 600 moves toward the display panel 200 and away from the light-controlling element 300. As such, the light beam emitted from the light-controlling element 300 is spread by the switching element 600, so that the stereoscopic display 1000 may display the two-dimensional image.

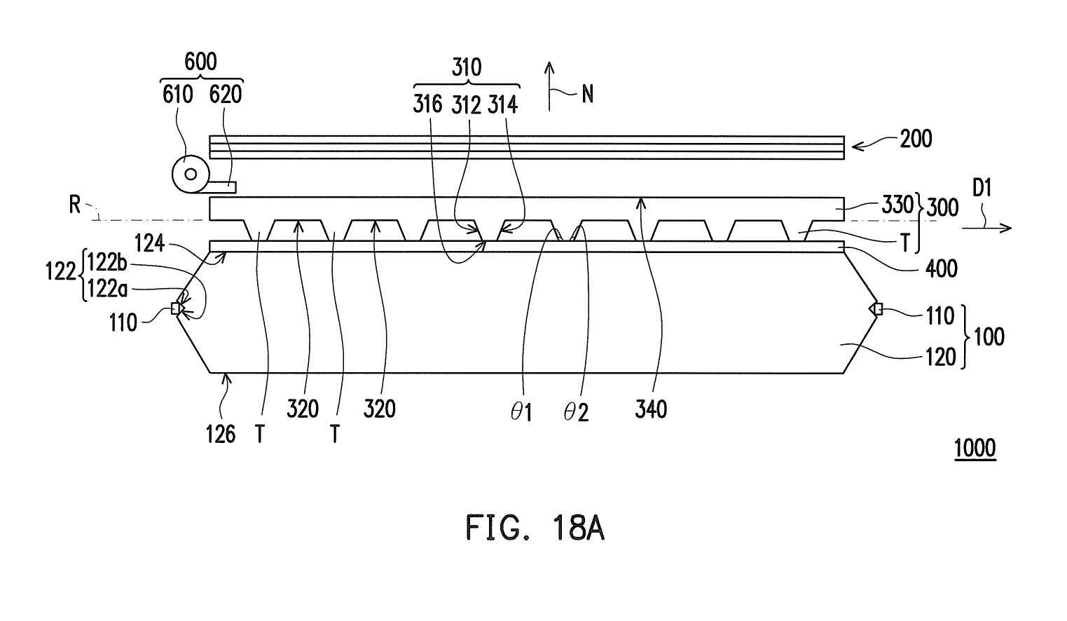

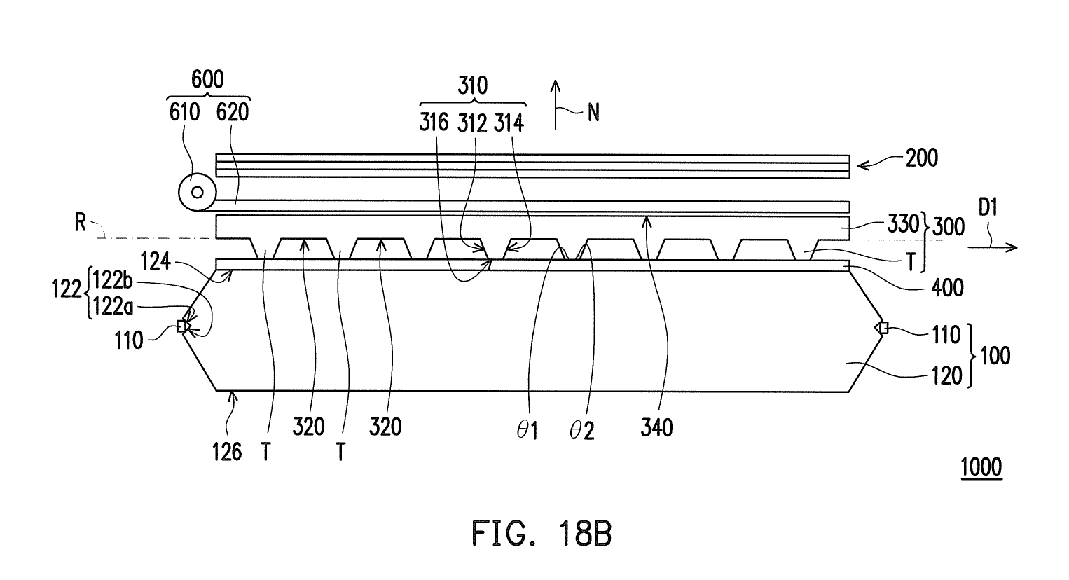

FIG. 18A and FIG. 18B are schematic cross-sectional diagrams of a stereoscopic display according to yet another exemplary embodiment. Referring to FIG. 18A and FIG. 18B, in this embodiment, the switching element 600 may be a light scattering structure. As shown in FIG. 18A, when the switching element 600 is switched from the light scattering mode to the light transmitting mode, the switching element 600 leaves from between the display panel 200 and the light-controlling element 300. In detail, the switching element 600 of this embodiment comprises a rotation shaft 610 and a scattering sheet 620 installed on the rotation shaft 610. When the switching element 600 is switched from the light scattering mode to the light transmitting mode, the rotation shaft 610 may roll up the scattering sheet 620 to enable the scattering sheet 620 to leave from between the display panel 200 and the light-controlling element 300. Now, the scattering sheet 620 is unable to scatter the light beam emitted from the light-controlling element 300, so that the stereoscopic display 1000 may display the three-dimensional image. As shown in FIG. 18B, when the switching element 600 is switched from the light transmitting mode to the light scattering mode, the switching element 600 may move to between the display panel 200 and the light-controlling element 300. In detail, when the switching element 600 is switched from the light transmitting mode to the light scattering mode, the rotation shaft 610 may actuate the scattering sheet 620 to enable the scattering sheet 620 to move to between the display panel 200 and the light-controlling element 300. Now, the scattering sheet 620 may scatter the light beam emitted from the light-controlling element 300, so that the stereoscopic display 1000 may display the two-dimensional image.

### Second Exemplary Embodiment

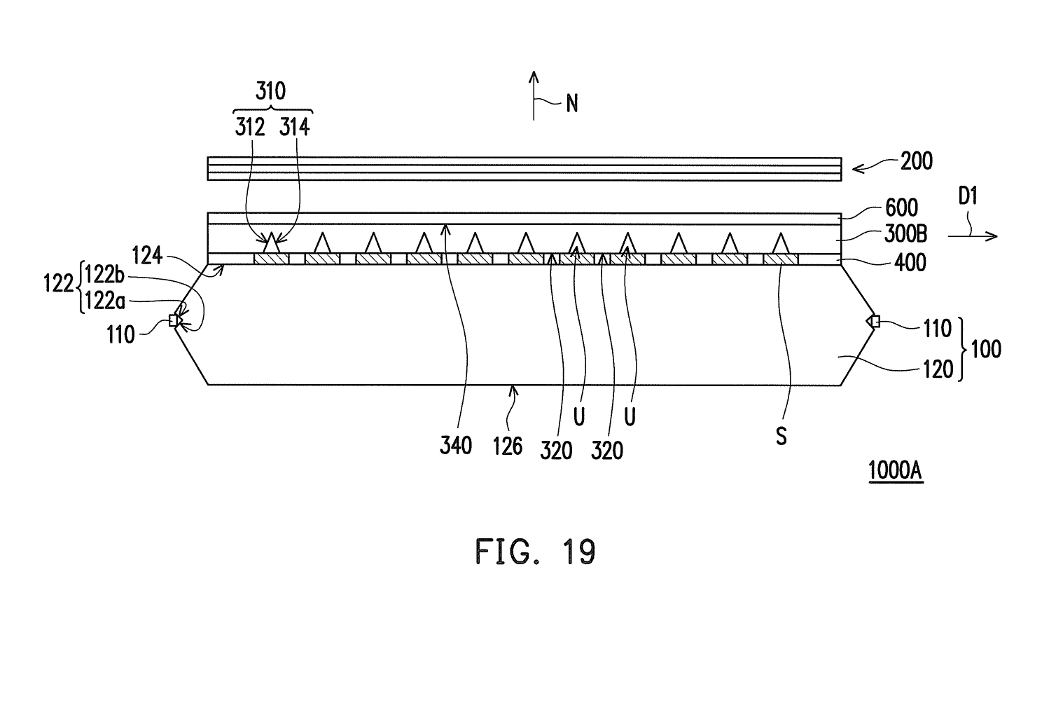

FIG. 19 is a schematic cross-sectional diagram illustrating a stereoscopic display according to a second exemplary embodiment. Referring to FIG. 19, a stereoscopic display 1000A of this embodiment is similar to the stereoscopic display 1000 of the first embodiment. Therefore, same elements are represented with the same labels. A difference between the stereoscopic display 1000A of this embodiment and the stereoscopic display 1000 of the first embodiment is that: in this embodiment, the light-controlling element 300B is different from the light-controlling element 300 of the first embodiment. Descriptions regarding the difference are provided in the following, whereas similarities between the two are not to be repeated.

The light-controlling element 300B of this embodiment is disposed between the display panel 200 and the light guide plate 120. The light-controlling element 300B comprises a plurality of light-controlling surface groups 310. Each of the light-controlling surface groups 310 has the first surface 312 and the second surface 314 opposite to each other. The first surfaces 312 and the second surfaces 314 of the light-controlling surface groups 310 are arranged along the first direction D1 substantially parallel to the light emitting surface 124. At least one of the first surface 312 and the second surface 314 inclines with respect to the light emitting surface 124 by over 90 degrees. The light-controlling element 300B of this embodiment further comprises a plurality of strip-shaped recesses U. Each of the strip-shaped recesses U has the first surface 312 and the second surface 314 of one of the light-controlling surface groups 310.

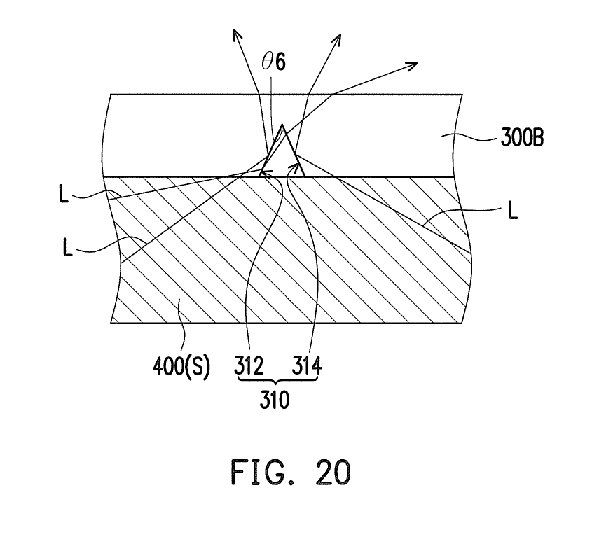

FIG. 20 and FIG. 19 are partial diagrams illustrating a light-controlling element and a light valve. Referring to FIG. 20, in this embodiment, the first surfaces 312 and the second surfaces 314 of the light-controlling surface groups 310 may also reflect or refract the light beam L out of the light-controlling element 300B, so as to form the line light sources. In this embodiment, the first surface 312 and the second surface 314 of each of the light-controlling surface groups 310 may be directly connected. An acute angle θ6 between the first surface 312 and the second surface 314 of each of the light-controlling surface groups 310 may fall within a range of 40 degrees to 60 degrees, but the disclosure is not limited thereto.

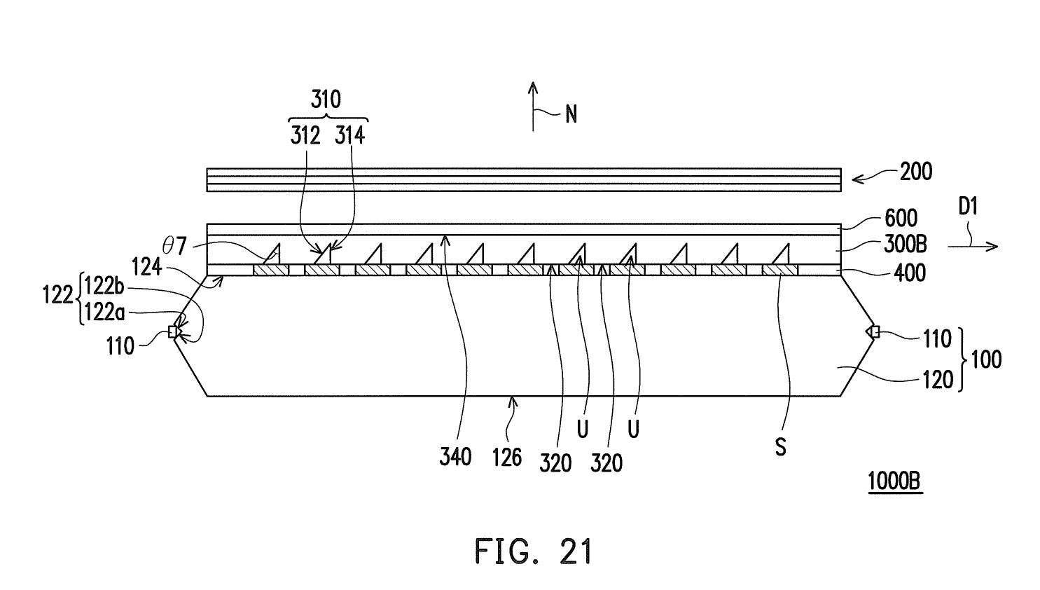

In this embodiment, the first surface 312 and the second surface 314 may both incline with respect to the light emitting surface 124 by over 90 degrees. However, the disclosure is not limited thereto. FIG. 21 is a schematic cross-sectional diagram illustrating a stereoscopic display according to another exemplary embodiment. Referring to FIG. 21, in a stereoscopic display 1000B, the first surface 312 of each of the light-controlling surface groups 310 may incline with respect to the light emitting surface 124. The second surface 314 of each of the light-controlling surface groups 310 is substantially perpendicular to the light emitting surface 124. The first surface 312 of each of the light-controlling surface groups 310 is located between the light incident surface 122 and the second surface 314. An acute angle θ7 between the first surface 312 and the second surface 314 of the light-controlling surface groups 310 falls within a range of 20 degrees to 30 degrees.

Other components of the stereoscopic displays 1000A, 1000B may be referred to the labels in FIG. 19, FIG. 21 for the corresponding descriptions given in the first embodiment. In addition, the stereoscopic displays 1000A, 1000B may also be applied to the variety of operation modes illustrated in the multiple embodiments mentioned above, and thus the details are not to be repeated herein.

In summary, the stereoscopic display of one embodiment may couple the light beam of the light guide plate into the light-controlling surface groups of the light-controlling element via the light-controlling element to faun the line light sources, so that the stereoscopic display may display the stereoscopic image.

The stereoscopic display of another embodiment may enable the stereoscopic display to be operated at the time multiplexing mode via the light valve, so that the stereoscopic display may display the high resolution stereoscopic image.

The stereoscopic display of yet another embodiment may enable the stereoscopic display to display the two-dimensional image or the three-dimensional image via the switching element, so that functions of the stereoscopic display are more diverse.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A stereoscopic display comprising:
a backlight module comprising:
a light source configured to emit a light beam; and
a light guide plate having a light incident surface and a light emitting surface, the light beam entering the light guide plate from the light incident surface and leaving the light guide plate from the light emitting surface;
a display panel;
a light-controlling element disposed between the display panel and the light guide plate, the light-controlling element comprising:
a plurality of light-controlling surface groups, each of the light-controlling surface groups having a first surface and a second surface opposite to each other, the first surfaces and the second surfaces of the light-controlling surface groups arranged along a first direction substantially parallel to the light emitting surface, at least one of the first surface and the second surface inclining with respect to the light emitting surface by over 90 degrees; and
a switching element configured to switch between a light transmitting mode and a light scattering mode, wherein when the switching element is switched to the light transmitting mode, the stereoscopic display displays a three-dimensional image, and when the switching element is switched to the light scattering mode, the stereoscopic display displays a two-dimensional image.

2. The stereoscopic display as recited in claim 1, wherein the light-controlling element further comprising:
a plurality of strip-shaped protrusions, each of the strip-shaped protrusions having the first surface and the second surface of one of the light-controlling surface groups.

3. The stereoscopic display as recited in claim 2, wherein the light-controlling element further comprises:
a plurality of bottom surfaces alternately arranged with the strip-shaped protrusions, wherein the strip-shaped protrusions are disposed between a reference plane where the bottom surfaces are located and the light emitting surface of the light guide plate.

4. The stereoscopic display as recited in claim 2, wherein the light-controlling element further comprises:
a plurality of bottom surfaces alternately arranged with the strip-shaped protrusions, wherein a reference plane where the bottom surfaces are located is disposed between the strip-shaped protrusions and the light emitting surface of the light guide plate.

5. The stereoscopic display as recited in claim 2, wherein each of the light-controlling surface groups further comprises a third surface connecting the first surface and the second surface, the third surface is substantially parallel to the light emitting surface of the light guide plate, and each of the strip-shaped protrusions having the first surface, the second surface and the third surface of one of the light-controlling surface groups.

6. The stereoscopic display as recited in claim 2, wherein the first surface inclines a first angle with respect to the light emitting surface of the light guide plate, the second surface inclines a second angle with respect to the light emitting surface of the light guide plate, and at least one of the first angle and the second angle falls within a range of 110 degrees to 120 degrees.

7. The stereoscopic display as recited in claim 1, wherein the light-controlling element further comprises a plurality of strip-shaped recesses, and each of the strip-shaped recesses having the first surface and the second surface of one of the light-controlling surface groups.

8. The stereoscopic display as recited in claim 7, wherein the first surface and the second surface of each of the light-controlling surface groups are directly connected with each other.

9. The stereoscopic display as recited in claim 7, wherein an acute angle between the first surface and the second surface of each of the light-controlling surface groups falls within a range of 40 degrees to 60 degrees.

10. The stereoscopic display as recited in claim 7, wherein the light source is disposed beside the light incident surface, the first surface of each of the light-controlling surface groups inclines with respect to the light emitting surface of the light guide plate, the second surface of each of the light-controlling surface groups is substantially perpendicular to the light emitting surface, and the first surface of each of the light-controlling surface groups is located between the light incident surface of the light guide plate and the second surface.

11. The stereoscopic display as recited in claim 10, wherein an acute angle between the first surface and the second surface of each of the light-controlling surface groups falls within a range of 20 degrees to 30 degrees.

12. The stereoscopic display as recited in claim 1, wherein the light-controlling element further comprises a plurality of bottom surfaces and a top surface, the bottom surfaces are alternatively arranged with the light-controlling surface groups, the top surface is opposite to the bottom surfaces, wherein at least one of the top surface and the bottom surfaces is a light scattering surface.

13. The stereoscopic display as recited in claim 1, wherein the light-controlling element is located between the switching element and the light guide plate.

14. The stereoscopic display as recited in claim 1, wherein the switching element is located between the light-controlling element and the light guide plate.

15. The stereoscopic display as recited in claim 1, wherein the light guide plate is located between the light-controlling element and the switching element.

16. The stereoscopic display as recited in claim 1, wherein the switching element is an electric variable light scattering structure.

17. The stereoscopic display as recited in claim 1, wherein the switching element is a light scattering structure, the light scattering structure is located between the display panel and the light-controlling element, wherein when the switching element switches from the light scattering mode to the light transmitting mode, the switching element moves toward the light-controlling element, and when the switching element switches from the light transmitting mode to the light scattering mode, the switching element moves toward the display panel.

18. The stereoscopic display as recited in claim 1, wherein the switching element is a light scattering structure, wherein when the switching element switches from the light scattering mode to the light transmitting mode, the switching element leaves from between the display panel and the light-controlling element, and when the switching element switches from the light transmitting mode to the light scattering mode, the switching element moves to between the display panel and light-controlling element.

19. The stereoscopic display as recited in claim 1, wherein the light guide plate further has a bottom surface opposite to the light emitting surface, the light emitting surface is located between the display panel and the bottom surface, the light incident surface connects the light emitting surface and the bottom surface, the light source has an optical axis, the optical axis is located on a reference plane parallel to the light emitting surface, the light incident surface comprises a first sub-light incident surface and a second sub-light incident surface respectively located at two sides of the reference plane, the first sub-light incident surface connects the light emitting surface and the second sub-light incident surface, the second sub-light incident surface connects the first sub-light incident surface and the bottom surface, and the first sub-light incident surface and the second sub-light incident surface incline with respect to the reference plane and face toward the optical axis.

20. The stereoscopic display as recited in claim 19, wherein an angle between the first sub-light incident surface and the second sub-light incident surface within a material of the light guide plate falls within a range of 270 degrees to 300 degrees.

21. The stereoscopic display as recited in claim 19, wherein the light source is disposed in a recession constituted of the first sub-light incident surface and the second sub-light incident surface.

22. The stereoscopic display as recited in claim 19, wherein the light guide plate further has a first connecting surface connecting the first sub-light incident surface and the light emitting surface and a second connecting surface connecting the second sub-light incident surface and the bottom surface, the first connecting surface and the second connecting surface are respectively located at the two sides of the reference plane, and the first connecting surface and the second connecting surface incline with respect to the reference plane and face away from the optical axis of the light source.

23. The stereoscopic display as recited in claim 22, wherein each of an angle between the first connecting surface and the first sub-light incident surface within a material of the light guide plate and an angle between the second connecting surface and the second sub-light incident surface within the material of the light guide plate falls within a range of 40 degrees to 80 degrees.

24. The stereoscopic display as recited in claim 1 further comprising:
a light valve disposed between the light guide plate and the display panel, the light valve having a plurality of operation regions respectively corresponding to the light-controlling surface groups, wherein when any one of the operation regions opens, a portion of the light beam from the light source is transmitted to the display panel through the operation region, and when any one of the operation regions closes, a portion of the light beam from the light source is substantially unable to be transmitted to the display panel through the operation region; and
a control unit electrically connected to the display panel and the light valve, the operation regions are divided into a plurality of operation region groups, and the control unit opens the different operation region groups at different time points.

25. The stereoscopic display as recited in claim 24, wherein the operation regions are divided into N operation region groups, N is a positive integer greater than or equal to 2, and the control unit opens the N operation region groups by turns causes a timing for the light beam to pass through the operation region groups to match an image displayed by the display panel.

26. The stereoscopic display as recited in claim 24, wherein the display panel has a plurality of pixel groups, each of the pixel groups has a plurality of pixel rows, the light beam transmitted though and out from each of the operation region groups converges at a plurality of view zone respectively after passing through the pixel groups, and wherein disposed between two operation regions adjacent to each other in each of the operation region groups are N−1 operation regions of other N−1 operation region groups.

27. The stereoscopic display as recited in claim 26, wherein the pixel groups are M pixel groups, M is a positive integer greater than or equal to 2, and wherein disposed between two pixel rows adjacent to each other in each of the pixel groups are M−1 pixel rows respectively belonging to other M−1 pixel groups.

28. The stereoscopic display as recited in claim 27, wherein the control unit enables the M pixel groups to respectively display 1/N images of M different viewing angles at the same time.

29. The stereoscopic display as recited in claim 24, wherein the display panel has a plurality of pixel groups, each of the pixel groups has a plurality of pixel rows, and the operation regions are slanted or substantially parallel with respective to the pixel rows.

30. The stereoscopic display as recited in claim 1 further comprising:
a light valve disposed between the light guide plate and the display panel, the light valve having a plurality of operation regions respectively corresponding to the light-controlling surface groups; and
a control unit electrically connected to the display panel and the light valve, the display panel having a plurality of pixel groups, each of the pixel groups having a plurality of pixel rows, the control unit enabling the light beam to pass through the operation regions at the same time, and the light beam transmitted though and out from the operation regions respectively converged at a plurality of view zones after passing through the pixel groups.

31. The stereoscopic display as recited in claim 30, wherein the pixel groups are M pixel groups, M is a positive integer greater than or equal to 2, and wherein disposed between two pixel rows adjacent to each other in each of the pixel groups are M−1 pixel rows respectively belonging to other M−1 pixel groups.

32. The stereoscopic display as recited in claim 31, wherein the control unit enables the M pixel groups to respectively display images of M different viewing angles.

33. The stereoscopic display as recited in claim 30, wherein the operation regions are slanted or substantially parallel with respect to the pixel rows.

34. The stereoscopic display as recited in claim 24, wherein the light valve is a light coupling device, the light coupling device has a plurality of light couple switching regions, the light couple switching regions of the light coupling device are operation regions of the light valve, the light coupling device is disposed between the light guide plate and the light-controlling element, each of the light couple switching regions extends from the light guide plate to the light-controlling element, and the control unit controls a refractive index distribution of each of the light couple switching regions to control whether or not the light beam emitted from the light emitting surface is to pass through the light couple switching regions.

35. The stereoscopic display as recited in claim 34, wherein the control unit is configured to enable each of the light couple switching regions to completely filled with a first substance so that the light beam emitted from the light emitting surface passes through the light couple switching regions, the control unit is configured to enable each of the light couple switching regions to fill up the first substance at an end close to the light guide plate and fill up a second substance in contact with the first substance at the other end away from the light guide plate, so that the light beam emitted from the light emitting surface is totally reflected at a junction of the first substance and the second substance, wherein a refractive index of the first substance is greater than a refractive index of the second substance.

36. The stereoscopic display as recited in claim 35, wherein the refractive index of the first substance is substantially equal to a refractive index of the light guide plate.

37. The stereoscopic display as recited in claim 35, wherein the light coupling device comprises:
a first substrate;
a second substrate disposed between the first substrate and the light guide plate, the first substance and the second substance being filled between the first substrate and the second substrate;
a plurality of first films located between the second substrate and the whole of the first substance and the second substance, an orthogonal projection of each of the first films on the light emitting surface coinciding with an orthogonal projection of one of the light couple switching regions on the light emitting surface;
a plurality of second films located between the second substrate and the whole of the first substance and the second substance, each of the second films located between two light couple switching regions adjacent to each other, an adhesive force between the first substance and the first film being greater than an adhesive force between the first substance and the second film;
a plurality of first electrodes, each of the first electrodes disposed between the second substrate and the second film located at two opposite sides of the light couple switching region; and
at least one second electrode disposed between the first substrate and the second substrate, wherein the control unit enables a voltage difference between the first electrodes located at the two sides of each of the light couple switching regions and the second electrode to substantially be zero to enable the light couple switching regions to completely fill up the first substance, the control unit applies a voltage difference between the first electrodes located at the two sides of each of the light couple switching regions and the second electrode to enable the light couple switching regions to fill up the first substance at an end close to the light guide plate and fill up the second substance at the other end away from the light guide plate.

38. The stereoscopic display as recited in claim 37, wherein the first films are hydrophilic membranes, the second films are hydrophobic membranes, the first substance is ionized water, and the second substance is air.

39. The stereoscopic display as recited in claim 35, wherein the light coupling device comprises:
a first substrate;
a second substrate disposed between the first substrate and the light guide plate, the first substance and the second substance filled between the first substrate and the second substrate;
a second film disposed between the second substrate and the whole of the first substance and the second substance, an adhesive force between the second substance and the second film being smaller than an adhesive force between the first substance and the second film;
a plurality of first electrodes disposed between the second film and the second substrate, two opposite sides of each of the light couple switching regions disposed with one of the first electrodes; and
at least one second electrode disposed between the first substrate and the second substrate, the control unit applying a voltage difference between the first electrodes located at the two sides of each of the light couple switching regions and the second electrode to enable the light couple switching regions to completely fill up the first substance, the control unit enabling the voltage difference between the first electrodes located at the two sides of each of the light couple switching regions and the second electrode to substantially be zero to enable the light couple switching regions to fill up the first substance at an end close to the light guide plate and to fill up the second substance at the other end away from the light guide plate.

40. The stereoscopic display as recited in claim 39, wherein the second film is a hydrophobic membrane, the first substance is oil, and the second substance is ionized water.

41. A stereoscopic display comprising:
a backlight module comprising:
a light source configured to emit a light beam; and
a light guide plate having a light incident surface and a light emitting surface, the light beam entering the light guide plate from the light incident surface and leaving the light guide plate from the light emitting surface;
a display panel;
a light-controlling element disposed between the display panel and the light guide plate, the light-controlling element comprising:
a plurality of light-controlling surface groups, each of the light-controlling surface groups having a first surface and a second surface opposite to each other, the first surfaces and the second surfaces of the light-controlling surface groups arranged along a first direction substantially parallel to the light emitting surface, at least one of the first surfaces and the second surfaces inclines with respect to the light emitting surface by over 90 degrees;
a light valve disposed between the light guide plate and the display panel, the light valve having a plurality of operation regions respectively corresponding to the light-controlling surface groups, wherein when any one of the operation regions opens, a portion of light beam from the light source is transmitted to the display panel through the operation region, and when any one of the operation regions closes, a portion of the light beam from the light source is substantially unable to be transmitted to the display panel through the operation region; and
a control unit electrically connected to the display panel and the light valve, the operation regions divided into a plurality of operation region groups, and the control unit opens different operation region groups at different time points.

42. The stereoscopic display as recited in claim 41, wherein the operation regions are divided into N operation region groups, N is a positive integer greater than or equal to 2, the control unit opens the N operation region groups by turns and causes a timing for the light beam to pass through the operation region groups to match an image displayed by the display panel.

43. The stereoscopic display as recited in claim 42, wherein the display panel has a plurality of pixel groups, each of the pixel groups has a plurality of pixel rows, the light beam transmitted though and out from each of the operation region groups converges at a plurality of view zones respectively after passing through the pixel groups, and wherein disposed between two operation regions adjacent to each other in each of the operation region group are N−1 operation regions of other N−1 operation region groups.

44. The stereoscopic display as recited in claim 43, wherein the pixel groups are M pixel groups, M is a positive integer greater than or equal to 2, and wherein disposed between two pixel rows adjacent to each other in each of the pixel groups are M−1 pixel rows respectively belonging to other M−1 pixel groups.

45. The stereoscopic display as recited in claim 44, wherein the control unit enables the M pixel groups to respectively display 1/N images of M different viewing angles at the same time.

46. The stereoscopic display as recited in claim 41, wherein the display panel has a plurality of pixel groups, each of the pixel groups has a plurality of pixel rows, and the operation regions are slanted or substantially parallel with respective to the pixel rows.

47. The stereoscopic display as recited in claim 41 further comprising:
a light valve disposed between the light guide plate and the display panel, the light valve having a plurality of operation regions respectively corresponding to the light-controlling surface groups; and
a control unit electrically connected to the display panel and the light valve, the display panel having a plurality of pixel groups, each of the pixel groups having a plurality of pixel rows, the control unit enabling the light beam to pass through the operation regions at the same time, and the light beam transmitted though and out from the operation regions respectively converged at a plurality of view zones after passing through the pixel groups.

48. The stereoscopic display as recited in claim 47, wherein the pixel groups are M pixel groups, M is a positive integer greater than or equal to 2, and wherein disposed between two pixel rows adjacent to each other in each of the pixel groups are M−1 pixel rows respectively belonging to other M−1 pixel groups.

49. The stereoscopic display as recited in claim 48, wherein the control unit enables the M pixel groups to respectively display images of M different viewing angles

50. The stereoscopic display as recited in claim 47, wherein the operation regions are slanted or substantially parallel with respect to the pixel rows.

51. The stereoscopic display as recited in claim 41, wherein the light valve is a light coupling device, the light coupling device has a plurality of light couple switching regions, the light couple switching regions of the light coupling device are the operation regions of the light valve, the light coupling device is disposed between the light guide plate and the light-controlling element, each of the light couple switching regions extends from the light guide plate to the light-controlling element, and the control unit controls a refractive index distribution of each of the light couple switching regions to control whether or not the light beam emitted from the light emitting surface passes through the light couple switching regions.

52. The stereoscopic display as recited in claim 51, wherein the control unit is configured to enable each of the light couple switching regions to completely filled with a first substance so that the light beam emitted from the light emitting surface passes through the light couple switching regions, the control unit is configured to enable each of the light couple switching regions to fill up the first substance at an end close to the light guide plate and fill up a second substance in contact with the first substance at the other end away from the light guide plate, so that the light beam emitted from the light emitting surface is totally reflected at a junction of the first substance and the second substance, wherein a refractive index of the first substance is greater than a refractive index of the second substance.

53. The stereoscopic display as recited in claim 52, wherein the refractive index of the first substance is substantially equal to a refractive index of the light guide plate.

54. The stereoscopic display as recited in claim 52, wherein the light coupling device comprises:
a first substrate;
a second substrate disposed between the first substrate and the light guide plate, the first substance and the second substance being filled between the first substrate and the second substrate;
a plurality of first films located between the second substrate and the whole of the first substance and the second substance, an orthogonal projection of each of the first films on the light emitting surface coinciding with an orthogonal projection of each of the light couple switching regions on the light emitting surface;
a plurality of second films located between the second substrate and the whole of the first substance and the second substance, each of the second films located between two light couple switching regions adjacent to each other, an adhesive force between the first substance and the first film being greater than an adhesive force between the first substance and the second film;
a plurality of first electrodes, each of the first electrodes disposed between the second substrate and the second film located at two opposite sides of the light couple switching region; and
at least one second electrode disposed between the first substrate and the second substrate, the control unit enabling a voltage difference between the first electrodes located at the two sides of each of the light couple switching regions and the second electrode to substantially be zero to enable the light couple switching regions to completely fill up the first substance, the control unit applying a voltage difference between the first electrodes located at the two sides of each of the light couple switching regions and the second electrode to enable the light couple switching regions to fill up the first substance at an end close to the light guide plate and fill up the second substance at the other end away from the light guide plate.

55. The stereoscopic display as recited in claim 54, wherein the first films are hydrophilic membranes, the second films are hydrophobic membranes, the first substance is ionized water, and the second substance is air.

56. The stereoscopic display as recited in claim 52, wherein the light coupling device comprises:
a first substrate;
a second substrate disposed between the first substrate and the light guide plate, the first substance and the second substance filled between the first substrate and the second substrate;
a second film disposed between the second substrate and the whole of the first substance and the second substance, an adhesive force between the second substance and the second film being smaller than an adhesive force between the first substance and the second film;
a plurality of first electrodes disposed between the second film and the second substrate, and two opposite sides of each of the light couple switching regions disposed with one of the first electrodes; and
at least one second electrode disposed between the first substrate and the second substrate, the control unit applying a voltage difference between the first electrodes located at the two sides of each of the light couple switching regions and the second electrode to enable the light couple switching regions to completely fill up the first substance, the control unit enabling a voltage difference between the first electrodes and the second electrode located at the two sides of each of the light couple switching regions to substantially be zero to enable the light couple switching regions to fill up the first substance at an end close to the light guide plate and to fill up the second substance at the other end away from the light guide plate.

57. The stereoscopic display as recited in claim 56, wherein the second film is a hydrophobic membrane, and the first substance and the second substance are two immiscible liquids.

58. A stereoscopic display comprising:
a backlight module comprising:
a light source configured to emit a light beam; and
a light guide plate having a light incident surface and a light emitting surface, the light beam entering the light guide plate from the light incident surface and leaving the light guide plate from the light emitting surface;
a display panel; and
a light-controlling element disposed between the display panel and the light guide plate, the light-controlling element comprising:
a plurality of light-controlling surface groups, each of the light-controlling surface groups having a first surface and a second surface opposite to each other, the first surface inclines a first angle with respect to the light emitting surface of the light guide plate, the second surface inclines a second angle with respect to the light emitting surface of the light guide plate, and at least one of the first angle and the second angle falls within a range of 110 degrees to 120 degrees.
